(19) United States
(12) Patent Application Publication
(10) Pub. No.: US 2025/0377730 A1
(43) Pub. Date: Dec. 11, 2025

(54) TOUCH SENSING FOR NEAR-EYE DISPLAY SYSTEMS USING VIBRATIONS AND ACOUSTICS

(71) Applicant: GOOGLE LLC, Mountain View, CA (US)

(72) Inventors: Farbod Motlagh, Seattle, WA (US); Dongeek Shin, Santa Clara, CA (US); Lidan Mu, Mountain View, CA (US); Jamie Alexander Zyskowski, Everett, WA (US)

(21) Appl. No.: 18/737,727

(22) Filed: Jun. 7, 2024

(51) Int. Cl. G06F 3/01; G02B 27/01; G06F 3/0346; G06F 3/041; G06F 3/043

(52) U.S. Cl. CPC G06F 3/017; G06F 3/0346; G06F 3/04182; G06F 3/043; G02B 27/0172

(57) ABSTRACT

A near-eye display (NED) system analyzes a set of sensor data. The set of sensor data includes one or both of inertial sensor data, such as accelerometer data, or acoustic sensor data, such as microphone data, obtained from one or more sensors of the NED system. Based on the analysis of the set of sensor data and in response to a detection that the set of sensor data includes one or more of inertial characteristics or acoustic characteristics corresponding to a gesture, the NED system generates an indication that a gesture has occurred and one or more operations of the NED system are controlled in response to the indication.

### BACKGROUND

Near-eye display (NED) systems, such as augmented reality glasses (AR), mixed reality glasses (XR), and virtual reality (VR) headsets, are designed to project digital content directly before the user's eyes, creating an immersive and interactive experience. By leveraging advanced display and optical technologies, NED systems offer users a blend of the digital and physical worlds (in the case of AR and XR) or a complete immersion into virtual landscapes (with VR).

### SUMMARY OF EMBODIMENTS

In accordance with one aspect, a method, at a near-eye display (NED) system, includes analyzing a first set of sensor data, including one or both of inertial sensor data or acoustic sensor data, obtained from one or more sensors of the NED system. An indication that a swipe gesture has occurred at the NED system is then generated based on the analyzing and in response to detecting that the first set of sensor data includes one or both of inertial characteristics or acoustic characteristics corresponding to a swipe gesture, generating an indication that a swipe gesture has occurred at the NED system.

In accordance with another aspect, a near-eye display (NED) system, includes an image source to project light representing imagery, a waveguide to conduct the light from the image source toward an eye of a user, and a processing device. The processing device is configured to perform an analysis of a first set of sensor data, including one or more of inertial sensor data or acoustic sensor data, obtained from one or more sensors of the NED system. The processing device generates an indication that a swipe gesture has occurred at the NED system in response to the analyzing and detecting that the first set of sensor data includes one or more of inertial characteristics or acoustic characteristics corresponding to a swipe gesture. The processing device controls the image source based on the indication that the swipe gesture has occurred.

In accordance with a further aspect, a method at a near-eye display (NED) system, includes obtaining an input stream from one or more of a set of inertial sensors or a set of acoustic sensors of the NED system. At least one neural network analyzes the input stream and determines that the input stream includes one or more of an inertial characteristic or an acoustic characteristic corresponding to a gesture having a directional component in response to the analyzing. A gesture having a directional component performed on the NED system is detected based on the one or more of the inertial characteristic or the acoustic characteristic. At least one operation of the NED system is controlled responsive to the detecting that the gesture has been performed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a near-eye display (NED) system in accordance with some embodiments.

FIG. 2 is a diagram illustrating a light projection system having an optical scanner that includes an optical relay disposed between two scan mirrors in accordance with some embodiments.

FIG. 3 is a block diagram illustrating an example hardware configuration for a processing device implemented by the NED system in accordance with some embodiments.

FIG. 4 is a diagram illustrating a swipe gesture being performed on an NED system in accordance with some embodiments.

FIG. 5 illustrates a waveform of an accelerometer signal capturing a swipe gesture performed on an NED system in accordance with some embodiments.

FIG. 6 illustrates a waveform of a microphone signal capturing a swipe gesture performed on an NED system in accordance with some embodiments.

FIG. 7 illustrates a waveform of a microphone signal capturing a backward swipe gesture performed on an NED system in accordance with some embodiments.

FIG. 8 illustrates a waveform of a microphone signal capturing a forward swipe gesture performed on an NED system in accordance with some embodiments.

FIG. 9 is a diagram illustrating a machine learning (ML) module employing a neural network for detecting swipe gestures at the NED system of FIG. 1 in accordance with some embodiments.

FIG. 10 is a block diagram illustrating a convolutional neural network (CNN) architecture that processes sensor data in the time domain and is designed for swipe gesture detection at the NED system of FIG. 1 in accordance with some embodiments.

FIG. 11 is a block diagram illustrating another CNN architecture that processes sensor data in the time-frequency domain and is designed for swipe gesture detection at the NED system of FIG. 1 in accordance with some embodiments.

FIG. 12 is a block diagram illustrating a temporal CNN architecture that processes sensor data in the time domain and is designed for swipe gesture detection at the NED system of FIG. 1 in accordance with some embodiments.

FIG. 13 is a block diagram illustrating another temporal CNN architecture that implements residual connections for processing sensor data in the time-frequency domain and is designed for swipe gesture detection at the NED system of FIG. 1 in accordance with some embodiments.

FIG. 14 is a flow diagram illustrating an example method of training a neural network for detecting swipe gestures at an NED system based on one or both of inertial or acoustic sensor data in accordance with some embodiments.

FIG. 15 is a flow diagram illustrating an example method of detecting swipe gestures at an NED system based on one or both of inertial or acoustic sensor data in accordance with some embodiments.

### DETAILED DESCRIPTION

Interacting with near-eye display (NED) systems, such as AR glasses, XR glasses, and VR headsets, has increasingly shifted towards utilizing gesture inputs, specifically those involving finger or hand movements across the device. The approach of gesture inputs aims to leverage the natural, intuitive motions of users for interaction, focusing on swipes, taps, and similar gestures to navigate menus, select options, or manipulate virtual objects. These gestures are recognized through sensors embedded in the devices, designed to capture the nuances of hand and finger movements.

However, the reliance on finger and hand gestures across NED systems introduces several challenges. For example, slight variations in movement speed, angle, and distance can affect the accuracy of input detection. A system's ability to correctly interpret these gestures provides a seamless user experience, yet this precision is difficult to achieve consistently across different user behaviors and environments. Computational demand is another issue for gesture recognition in NED systems. Processing the data from sensors to recognize gestures in real time requires computational resources, impacting the device's performance and battery life. This challenge is exacerbated by the need for the software to continuously adapt to variations in gesture execution by different users, further straining system resources. Environmental factors also pose challenges for recognizing finger and hand gestures. Background movements, lighting conditions, and even the device's position relative to the user can interfere with gesture detection. In crowded or dynamic environments, the device may mistakenly register unintended movements as gestures, leading to errors in user interaction. Moreover, the requirement for users to learn specific gestures for different actions introduces a learning curve that can detract from the intuitiveness of NED systems. Users not only need to remember a set of gestures but also how to perform them correctly to be recognized by the system, which can limit the accessibility and appeal of gesture-based interactions, particularly for new or infrequent users.

As such, the following describes embodiments of systems and methods for more efficiently and more accurately detecting swipe gestures on an NED system. As described in greater detail below, an NED system includes a detection component that implements one or more sensors that transduce physical phenomena (e.g., sound waves, acceleration forces, vibrations, etc.) into electrical signals. Examples of these sensors include a microphone, an inertial measurement unit (IMU), and the like. In embodiments, the sensors detect physical phenomena as a user interacts with the NED system. For example, as the user slides a finger across a portion of the frame, such as a temple, the sensor(s) detects sound waves, acceleration forces, vibrations, a combination thereof, or other physical phenomena generated by this interaction, and transduces these physical phenomena into electrical signals.

The detection component processes these electrical signals (or representations thereof) to detect if the user has performed a swipe gesture on the NED system. In at least some embodiments, the detection component is configured to detect multiple different types of swipe gestures, such as a full backward swipe, a full forward swipe, a full upward swipe, a full downward swipe, a half backward swipe, a half forward swipe, a half upward swipe, and a half downward swipe. The detection component is also configured to distinguish a swipe gesture from other on-device gestures, such as a tap, a double tap, and the like, based on one or more characteristics of the gestures, such as directionality, duration, touch size area, and the like. For instance, when a user executes a swipe gesture, this action includes a directional aspect, such as left, right, upward, or downward. Conversely, when a user performs a tap gesture, this action lacks a directional component, as a tap gesture does not involve movement in specific directions. Also, a swipe gesture typically spans a longer duration than a tap gesture. Moreover, the touch area size of a swipe gesture is typically larger than the touch area size of a tap gesture. The detection component identifies these differences in gesture characteristics to determine when a user's interaction with the NED system is a swipe gesture instead of another type of on-device gesture.

In at least some embodiments, the detection component is also configured to detect swipe gestures based on the components or phases of a gesture within raw or processed (e.g., filtered) sensor signals, such as an accelerometer signal, a microphone signal, a combination thereof, and the like. Components of a swipe gesture in an accelerator signal (or its waveform representation) include, for example, an impact, a vibrational swipe, a release, or other components related to the gesture's physical aspects. Components of a swipe gesture in a microphone signal (or its waveform representation) include, for example, an onset, a steady state, a decay, or other components related to the gesture's auditory aspects. The detection component, in at least some embodiments, not only detects swipe gestures based on these components but also detects or identifies gesture attributes, such as direction (e.g., forward, downward, up, and down) and swipe magnitude (e.g., full swipe or half swipe).

The detection component, in at least some embodiments, implements one or more machine learning (ML) models to detect or make an inference whether a swipe gesture has been performed by a user on the NED system. In at least some embodiments, the one or more ML models are neural networks, such as a deep neural network(s) (DNNs) including convolutional neural networks (CNNs). However, examples of other applicable DNNs include recurrent neural networks (RNNs), long short-term memory (LSTM) networks, gated recurrent unit (GRU) networks, time-delay neural networks (TDNNS), and the like.

In at least some embodiments, the detection component, another component of the NED system, or a remote system trains a DNN or multiple DNNs to detect the multiple different types of swipe gestures described above. In embodiments implementing multiple DNNs, the detection component individually trains one or more DNNs, jointly trains multiple DNNs, or a combination thereof. During training, the DNN(s) defined by a DNN architectural configuration(s), in at least some embodiments, adaptively learns based on supervised learning. In supervised learning, the DNN receives and processes various types of input data as training data to learn how to map the input to a desired output. As an example, the DNN receives one or more of accelerometer signals, microphone signals, waveforms representing accelerometer signals, waveforms representing microphone signals, a combination thereof, or the like. The DNN learns how to map this input training data to, for example, different swipe gestures, such as a full backward swipe, a half backward swipe, a full forward swipe, a half forward swipe, a full upward swipe, a half upward swipe, a full downward swipe, a half downward swipe, a full diagonal swipe, a half diagonal swipe, and the like. Stated differently, the DNN learns how to map input training samples to gestures of interest and gestures not of interest.

The training data, in at least some embodiments, includes labeled or known data as an input to the DNN(s) being trained. For example, the labeled data includes positive samples for the different types of samples and negative samples for actions such as taps, holds, frame adjustments, speech, chewing, humming, walking, head movement (e.g., shaking), and the like. The labels, in at least some embodiments, include one or more of start and stop timestamps for each swipe gesture and non-swipe gesture event. In at least some embodiments, the labels for accelerometer data include additional labels identifying the components of a swipe gesture described above, such as an impact, a vibrational swipe, a release, or other components related to the gesture's physical aspects. The labels for microphone data include additional labels identifying components of a swipe gesture described above, such as an onset, a steady state, a decay, or other components related to the gesture's auditory aspects.

In at least some embodiments, the detection component (or remote system) implements a heuristic automatic labeler to generate the labels for the training data. For example, the automatic labeler obtains input sensor data, such as raw accelerometer, microphone signals, or a combination, and applies a filter, such as a first-order Infinite Impulse Response (IIR) filter, to the input sensor data to remove low-frequency (e.g., below 50 Hz, 1 kHz, 20 kHz, etc.) artifacts. The automatic labeler performs principal component analysis (PCA) to reduce the filtered signal to one dimension and then performs a Fast Fourier Transform (FFT) to transform the signal to the time-frequency domain. After applying another filter, such as a Gaussian filter, to smooth the transformed signal, the automatic labeler calculates the mean of high-frequency bands and finds the local maxima. The automatic labeler uses the identified local maxima to generate labels, such as the start and end events of a swipe gesture, for the sensor data.

The detection (or remote) system, in at least some embodiments, generates training samples based on the sensor input data labeled by the automatic labeler, humans, or a combination thereof. In at least some embodiments, the detection component implements a sliding window approach in which the detection component simplifies swipe detection to a classification problem where a sensor input window S is mapped to a gesture probability vector G that includes all the possible gestures and a background (or idle) class. The detection component uses a sliding window W over the sensor input stream and determines its gesture probability vector based on the following process. For example, the detection component processes the labeled sensor input data for each window C and identifies the closest labeled gesture event G with an end timestamp of E. If end timestamp E of the window C is within the interval defined by [E+pad, E+pad+perturb], then the detection component identifies and uses C as a positive training sample of G. Otherwise, the detection component identifies and uses C as a training sample for background (idle class). Here, pad is an amount of time that is added to the end timestamp E to include any post-event contextual information and to help mitigates any human error in labeling, and perturb is an amount of time added after the pad to help with model robustness.

Based on the labeled training data, the DNN is trained to recognize patterns in the input signals or waveforms corresponding to these components of a swipe gesture to accurately detect when a swipe gesture is performed on the NED system and the type of swipe gesture that was performed. For example, the DNN employs statistical analysis and adaptive learning to map inputs to outputs, using learned characteristics to correlate unknown inputs with statistically likely outputs. After training, the performance of the DNN is assessed using test or hold-back data, and the detection (or remote system) stores or associates the learned parameters, such as weights and biases, with the architectural configuration of the DNN.

The detection component implements a single DNN, multiple DNNs having the same architecture, or multiple DNNs having a different architecture. In at least some embodiments, the same or different architectures are used for DNNs depending on the type of data being processed, such as raw accelerometer data, raw microphone data, preprocessed accelerometer data (e.g., Short-Time Fourier Transform (STFT) accelerometer data), preprocessed microphone data (e.g., STFT microphone data), a combination thereof, or the like.

In at least some embodiments, the DNN(s) implemented by the detection component is a CNN. In at least some of these embodiments, the architecture of the CNN for processing accelerometer data includes a one-dimensional (1D) convolutional layer(s), a batch normalization (BN) layer(s), a rectified linear unit (ReLU) activation layer(s), a max pooling layer(s), and an output layer. The 1D convolutional layer(s) applies convolution operations to extract features from input sequences. During training, batch normalization is applied after each convolutional layer to ensure stability and efficiency by normalizing the layer inputs based on the current mini-batch statistics. These statistics are then fixed and used during the inference phase, ensuring consistent performance across different stages. The ReLU activation layer(s) introduces non-linearity at both stages, enabling the model to capture and utilize complex patterns learned during training when making predictions on new data. The max pooling layer(s) reduces dimensionality, simplifies the model structure, and mitigates overfitting risks, which enhances model generalization from training to inference. The output layer, such as a fully connected (FC) layer, is responsible for producing the final prediction by integrating learned features from previous layers tailored to the specific task, such as classification or regression. The output layer maps the extracted features to the output classes, which effectively translates the complex patterns recognized by the CNN into actionable predictions for each class.

In other embodiments, at least one CNN implemented for processing accelerometer data is a temporal convolutional neural network (TCN) that has an architecture including a dilated 1D convolutional layer in addition to the BN, ReLU, and max pooling layers described above. The dilated 1D convolutional layer uses dilation to expand the receptive field of the convolution without increasing the kernel size. This allows the network to capture long-range dependencies in the input sequence more effectively than a standard convolutional layer.

In at least some embodiments, the architecture of at least one CNN implemented by the detection component for processing microphone data includes a 1D convolutional layer(s), a BN layer(s), a ReLU layer(s), residual connections, and an output layer. The 1D convolutional layers, BN layers, ReLU layers, and output layers are similar to those described above. The residual connections bypass one or more layers by adding the input directly to the output of a layer or block of layers, ensuring consistent performance by leveraging the gradient flow learned during training. This technique helps in preserving the gradient flow across the network, facilitating the training of deeper architectures without performance degradation. In at least some embodiments, a normalized exponential function, such as softmax activation, is employed at the output layer during inference to convert logits into probabilities. This function ensures that the final predictions made by the CNN on microphone data are presented in a probabilistic format that is both interpretable and actionable.

As such, the techniques described herein for detecting swipe gestures on NED systems offer various advantages over conventional techniques, such as touch or gesture recognition. For example, the techniques of one or more embodiments improve gesture recognition accuracy and reliability by leveraging machine learning algorithms to analyze the data from sensors, such as an IMU and microphones, effectively distinguishing between deliberate gestures and accidental contacts. This not only reduces the instances of false positives but also ensures the device responds accurately to user inputs even in challenging environments where traditional touch-sensitive surfaces might falter due to moisture, dirt, or other interfering factors.

Furthermore, the techniques of one or more embodiments introduce an advancement in the durability and design flexibility of wearable devices. By relying on internal sensors for gesture detection, the physical wear and tear associated with direct contact on touch interfaces is minimized, thereby extending the device's lifespan and preserving its aesthetic appeal. The elimination of the need for designated touch-sensitive areas allows for sleeker and more seamless device designs, enhancing the overall user experience. Additionally, this approach ensures consistent and reliable performance across a wide range of environmental conditions, including when the user is wearing gloves, in wet conditions, or experiencing extreme temperatures, which are areas where traditional touchscreens and sensors may fall short.

Another advantage is the optimization for lower power consumption. Traditional methods that require continuous activation of touchscreens or sensors can quickly deplete battery life. In contrast, by using accelerometer and microphone data for gesture detection, especially when coupled with machine learning algorithms, the techniques described herein can be finely tuned to minimize energy usage without sacrificing responsiveness and ensuring the device remains energy-efficient. Moreover, the techniques of one or more embodiments offer enhanced privacy and security by processing gesture data internally without the need to capture or store visual information, thus addressing the privacy concerns associated with camera-based gesture recognition systems. The inclusion of machine learning also means that the system can adapt and personalize its interactions over time, learning from the user's habits and preferences to predict and respond to gestures more naturally and intuitively.

While the following description uses a swipe gesture as one type of gesture detectable by one or more techniques described herein, it is understood that non-swipe gestures, such as taps (e.g., gestures absent or without a directional component), are also detectable by the one or more techniques. The term “swipe gesture”, as used herein, includes a gesture that has a directional component, involving the movement of a user's finger, stylus, or other input device across a touch-sensitive surface or input area in a continuous motion. This gesture can vary in direction, speed, distance, and pattern, allowing for a wide range of interactions. Examples of swipe gestures include horizontal swipes, such as sliding a finger from left to right or right to left; vertical swipes, such as sliding a finger from top to bottom or bottom to top; and diagonal swipes, such as sliding a finger from top-left to bottom-right, top-right to bottom-left, bottom-left to top-right, or bottom-right to top-left. Additionally, swipe gestures encompass curved or arched swipes, multi-finger swipes, long swipes covering a significant distance, short swipes over a smaller area, rapid swipes characterized by high speed and short duration, and slow swipes characterized by low speed and longer duration. Complex swipe gestures include pinch and swipe, such as pinch-in swipe by bringing two fingers together while sliding them, or pinch-out swipe by spreading two fingers apart while sliding them. Zoom and swipe gestures include zoom-in swipe by sliding two fingers apart to zoom in on content, and zoom-out swipe by sliding two fingers together to zoom out. Rotate and swipe gestures involve sliding two or more fingers in a circular motion to rotate an object or view. Additionally, two-handed swipes involve using both hands to perform swipe gestures either in coordination or in different directions. Also, the techniques described herein are also applicable to detecting gestures that do not contact the NED system.

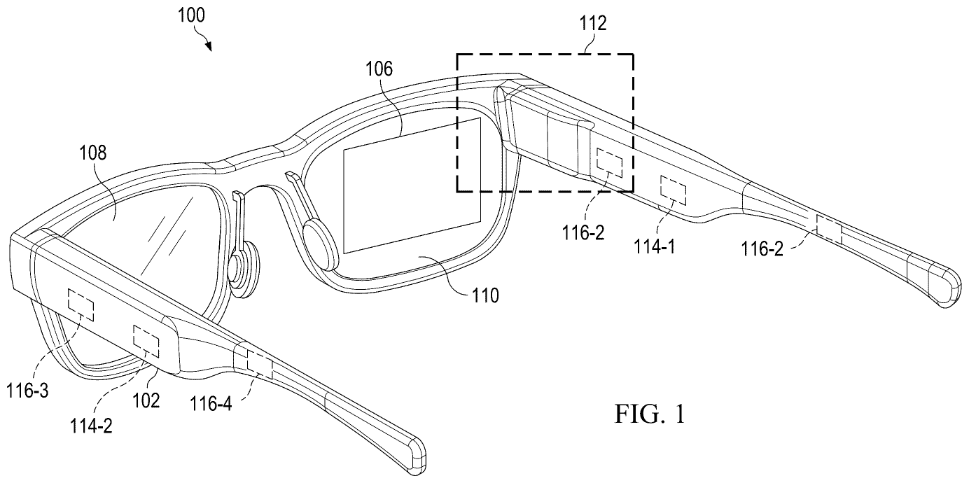

FIG. 1 illustrates an example near-eye display (NED) system 100 (also referred to herein as “display system 100” for implementing swipe gesture detection techniques in accordance with at least some embodiments. In the illustrated implementation, the NED system 100 utilizes an eyeglasses form factor. However, the NED system 100 is not limited to this form factor and, thus, may have a different shape and appearance from the eyeglasses frame depicted in FIG. 1. The NED system 100 includes a support structure 102 (e.g., a support frame) to mount to a head of a user and that includes an arm 104 that houses an image source, such as light projection system, including a micro-display (e.g., micro-light emitting diode (LED) display) or other light engine, configured to project display light representative of images or imagery toward the eye of a user, such that the user perceives the projected display light as a sequence of images displayed in a field of view (FOV) area 106 at one or both of lens elements 108, 110 supported by the support structure 102.

In at least some embodiments, the support structure 102 further includes various sensors, such as one or more inertial sensors 114 (illustrated as inertial sensor 114-1 and inertial sensor 114-2), such as an IMU or individual accelerometers, gyroscopes, magnetometers, and the like, and one or more microphones 116 (illustrated as microphone 116-1 to microphone 116-4). Additional sensors for the support structure 102, which are not shown in FIG. 1, include front-facing cameras, rear-facing cameras, other light sensors, motion sensors, and the like. The support structure 102, in at least some embodiments, further includes one or more radio frequency (RF) interfaces (not shown in FIG. 1) or other wireless interfaces, such as a Bluetooth™ interface, a Wi-Fi interface, and the like. The support structure 102, in at least some embodiments, further includes one or more batteries (not shown in FIG. 1) or other portable power sources for supplying power to the electrical components of the NED system 100. In at least some embodiments, some or all of these components of the NED system 100 are fully or partially contained within an inner volume of support structure 102, such as within region 112 or another region of the arm 104 of the support structure 102.

One or both of the lens elements 108, 110 are used by the NED system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes or conducts display light received by an incoupler (IC) (not shown in FIG. 1) of the waveguide to an outcoupler (OC) (not shown in FIG. 1) of the waveguide, which outputs the display light toward an eye of a user of the NED system 100. Additionally, the waveguide employs an exit pupil expander (EPE) (not shown in FIG. 1) in the light path between the IC and OC or in combination with the OC in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

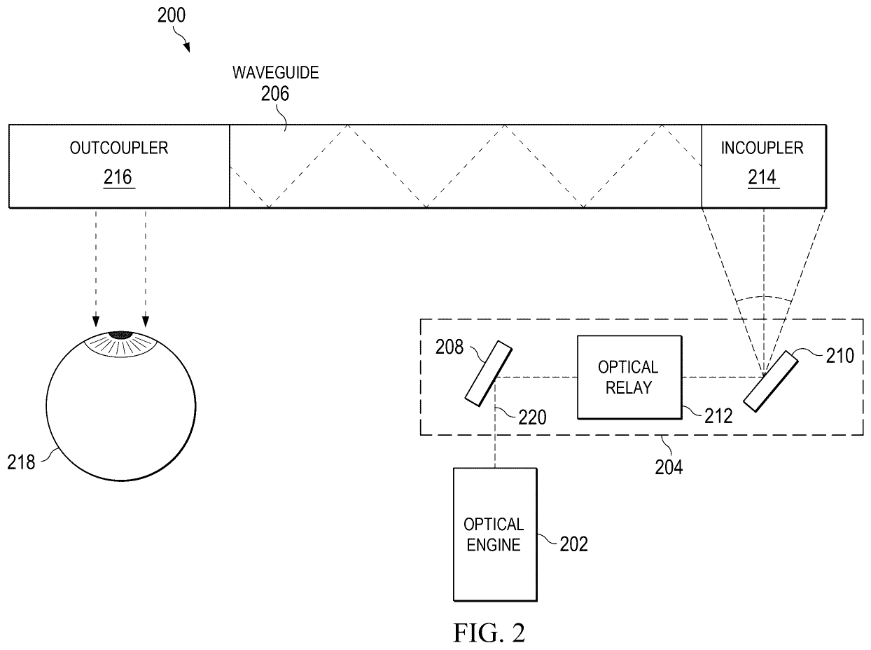

FIG. 2 illustrates a simplified block diagram of a projection system 200, such as a laser projection system, that projects images directly onto the eye of a user via laser light. It should be understood that the embodiments described herein are not limited to the projection system 200 of FIG. 2, and other projection systems are also applicable. The projection system 200, in at least some embodiments, is fully or partially contained within an inner volume of the NED system 100 of FIG. 1, such as within region 112 or another region of the arm 104 of the support structure 102. In at least some embodiments, the projection system 200 includes an optical engine 202, an optical scanner 204, and a waveguide 206. The optical scanner 204 includes a first scan mirror 208, a second scan mirror 210, and an optical relay 212. The waveguide 206 includes an incoupler 214 and an outcoupler 216, with the outcoupler 216 being optically aligned with an eye 218 of a user in the present example.

The optical engine 202 includes one or more light sources, such as laser light sources, configured to generate and output light 220 (e.g., visible laser light such as red, blue, and green laser light and, in some embodiments, non-visible laser light such as infrared laser light). In at least some embodiments, the optical engine 202 is coupled to a driver or other controller (not shown), which controls the timing of emission of light 220 from the light sources of the optical engine 202 in accordance with instructions received by the controller or driver from a computer processor coupled thereto to modulate the light 220 to be perceived as images when output to the retina of an eye 218 of a user. One or both of the first and second scan mirrors 208 and 210, in at least some embodiments, are micro-electro-mechanical systems (MEMs) mirrors. Oscillation of the first scan mirror 208 causes light 220 output by the optical engine 202 to be scanned through the optical relay 212 and across a surface of the second scan mirror 210. The second scan mirror 210 scans the light 220 received from the first scan mirror 208 toward an incoupler 214 of the waveguide 206.

In at least some embodiments, the incoupler 214 has a substantially rectangular profile and is configured to receive the light 220 and direct the light 220 into the waveguide 206. The incoupler 214 is defined by a smaller dimension (i.e., width) and a larger orthogonal dimension (i.e., length). In at least some embodiments, the optical relay 212 is a line-scan optical relay that receives the light 220 scanned in a first dimension by the first scan mirror 208 (e.g., the first dimension corresponding to the small dimension of the incoupler 214), routes the light 220 to the second scan mirror 210, and introduces a convergence to the light 220 (e.g., via collimation) in the first dimension to an exit pupil plane of the optical relay 212 beyond the second scan mirror 210. Herein, a “pupil plane” refers to a location along the optical path of laser light through an optical system where the laser light converges to an aperture along one or more dimensions.

While, in the present example, the optical engine 202 is shown to output a single beam of light 220 (which itself may be a combination of two or more beams of light having respectively different polarizations or wavelengths) toward the first scan mirror 208, in at least some embodiments, the optical engine 202 is configured to generate and output two or more light beams 220 toward the first scan mirror 208, where the two or more laser light beams are angularly separated with respect to one another (i.e., they are “angularly separated laser light beams”).

In the present example, the possible optical paths of the light 220, following reflection by the first scan mirror 208, are initially spread along a first scanning dimension, but later, these paths intersect at an exit pupil plane beyond the second scan mirror 210 due to convergence introduced by the optical relay 212. For example, the width (i.e., smallest dimension) of a given exit pupil plane approximately corresponds to the diameter of the laser light corresponding to that exit pupil plane. Accordingly, the exit pupil plane can be considered a “virtual aperture”. In at least some embodiments, the exit pupil plane of the optical relay 212 is coincident with the incoupler 214. An entrance pupil plane of the optical relay 212, in at least some embodiments, is coincident with the first scan mirror 208.

In at least some embodiments, the optical relay 212 includes one or more spherical, aspheric, parabolic, or freeform lenses that shape and relay the light 220 on the second scan mirror 210 or includes a molded reflective relay that includes two or more optical surfaces that include, but are not limited to, spherical, aspheric, parabolic, or freeform lenses or reflectors (sometimes referred to as “reflective surfaces” herein), which shape and direct the light 220 onto the second scan mirror 210. The second scan mirror 210 receives the light 220 and scans the light 220 in a second dimension, the second dimension corresponding to the long dimension of the incoupler 214 of the waveguide 206. In at least some embodiments, the second scan mirror 210 causes the exit pupil plane of the light 220 to be swept along a line along the second dimension. In at least some embodiments, the incoupler 214 is positioned at or near the swept line downstream from the second scan mirror 210 such that the second scan mirror 210 scans the light 220 as a line or row over the incoupler 214.

The waveguide 206 of the projection system 200 includes the incoupler 214 and the outcoupler 216. The term “waveguide,” as used herein, will be understood to mean a combiner using one or more of total internal reflection (TIR), specialized filters, or reflective surfaces, to transfer light from an incoupler (such as the incoupler 214) to an outcoupler (such as the outcoupler 216). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In at least some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In at least some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the light 220 received at the incoupler 214 is relayed to the outcoupler 216 via the waveguide 206 using TIR. The light 220 is then output to the eye 218 of a user via the outcoupler 216. As described above, in at least some embodiments, the waveguide 206 is implemented as part of an eyeglasses lens, such as the lens elements 108 or 110 (FIG. 1) of the NED system 100 having an eyeglass form factor and employing the projection system 200.

Although not shown in the example of FIG. 2, in at least some embodiments, additional optical components are included in any of the optical paths between the optical engine 202 and the first scan mirror 208, between the first scan mirror 208 and the optical relay 212, between the optical relay 212 and the second scan mirror 210, between the second scan mirror 210 and the incoupler 214, between the incoupler 214 and the outcoupler 216, or between the outcoupler 216 and the eye 218 (e.g., in order to shape the laser light for viewing by the eye 218 of the user). In at least some embodiments, a prism is used to steer light from the second scan mirror 210 into the incoupler 214 so that light is coupled into incoupler 214 at the appropriate angle to encourage propagation of the light in waveguide 206 by TIR. Also, in at least some embodiments, an exit pupil expander (not shown in FIG. 2), such as a fold or another grating, is arranged in an intermediate stage between incoupler 214 and outcoupler 216 to receive light that is coupled into waveguide 206 by the incoupler 214, expand the light, and redirect the light towards the outcoupler 216, where the outcoupler 216 then couples the laser light out of waveguide 206 (e.g., toward the eye 218 of the user).

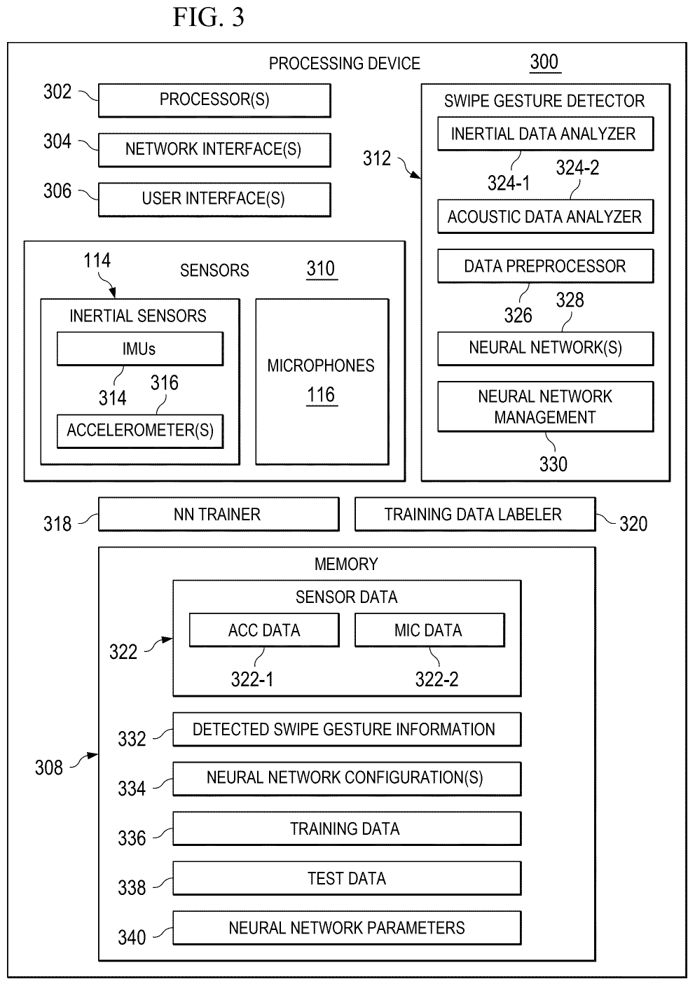

FIG. 3 illustrates an example hardware configuration for a processing device 300 implemented by the NED system 100 of FIG. 1 in accordance with at least some embodiments. Note that the depicted hardware configuration represents the processing components most directly related to the gesture detection techniques of one or more embodiments and omits certain components well-understood to be frequently implemented in a processing device. Although FIG. 3 illustrates individual components, in other embodiments, two or more components are combined into a single component. Also, the processing device 300 includes one or more additional or fewer components than illustrated in FIG. 3.

In at least some embodiments, the processing device 300 is fully or partially contained within an inner volume of the NED system 100 of FIG. 1, such as within region 112 or another region of the arm 104 of the support structure 102. The processing device 300, in at least some embodiments, includes one or more processors 302, one or more network interface(s) 304, one or more user interfaces 306, memory/storage 308, one or more sensors 310, and a swipe gesture detector 312 (also referred to herein as the “swipe gesture detection component 312” or “detection component 312”). The processing device 300, in at least some embodiments, further includes a neural network training component 318 and a training data labeling component 320. However, in other embodiments, one or more of the neural network training component 318 or the training data labeling component 320 are implemented at a processing device or system external to the NED system 100. In at least some implementations, one or more of these components of the processing device 300 are implemented as hardware, circuitry, software, firmware or a firmware-controlled microcontroller, or a combination thereof.

The processor(s) 302 includes, for example, one or more central processing units (CPUs), graphics processing units (GPUs), machine learning (ML) accelerator, tensor processing units (TPUs) or other application-specific integrated circuits (ASIC), or the like. The network interface(s) 304 enables the processing device 300 to communicate over one or more networks. The user interface(s) 306 enables a user to interact with the NED system. The memory/storage 308, in at least some embodiments, includes one or more computer-readable media that include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the memory/storage 308 is referred to herein as “memory 308” in view of the frequent use of system memory or other memory to store data and instructions for execution by the processor 302, but it will be understood that reference to “memory 308” shall apply equally to other types of storage media unless otherwise noted. The one or more memories 308 of the processing device 300 store one or more sets of executable software instructions and associated data that manipulate the processor(s) 302 and other components of the processing device 300 to perform the various functions attributed to the processing device 300. The sets of executable software instructions include, for example, an operating system (OS) and various drivers (not shown), and various software applications.

The sensors 310 include, for example, one or more inertial sensors 114 and one or more microphones 116. The inertial sensors 114 include, for example, IMUs 314, individual accelerometers 316, gyroscopes, magnetometers, a combination thereof, or the like. Additional sensors for the support structure 102, which are not shown in FIG. 3, include front-facing cameras, rear-facing cameras, other light sensors, motion sensors, and the like. In at least embodiments, the sensors 310 detect physical phenomena as a user interacts with the NED system 100. For example, as the user slides a finger across a portion of the support structure 102, such as a temple arm 104, the sensors 310 detects sound waves, acceleration forces, vibrations, rotational forces, a combination thereof, or other physical phenomena generated by this interaction, and generate sensor data 322 by, for example, transducing these physical phenomena into electrical signals or representations thereof. Examples of sensor data 322 include inertial data, such as accelerometer data 322-1 or gyroscope data, and acoustic data, such as microphone data 322-2. In at least some embodiments, the sensor data 322 is stored in the memory 308.

As described in greater detail below, the detection component 312 includes one or more data analyzers 324, such as an inertial data analyzer 324-1 and an acoustic data analyzer 324-2, that analyze or process the sensor data 322. For example, the inertial data analyzer 324-1 processes accelerometer data 322-1, and the acoustic data analyzer 324-2 processes microphone data 322-2. Based on this analysis, the detection component 312 detects gestures, such as swipe gestures or non-swipe gestures, performed by a user on the NED system 100. Stated differently, the detection component 312 detects gestures based on, for example, one or both of accelerometer data 322-1 or the acoustic data microphone data 322-2 captured by the sensors 310 as a result of a user physically interacting with the NED system 100. Although the example shown in FIG. 3 implements multiple data analyzers 324, a single data analyzer 324, in at least some embodiments, processes multiple different types of sensor data 322. The detection component 312 generates a set of detected swipe gesture information 332 (also referred to herein as “gesture information 332”), which, in at least some embodiments, is stored in the memory 308. The detected gesture information 332, in at least some embodiments, includes an indication that a swipe was detected (or not detected). In at least some embodiments, the detected gesture information 332 further includes attributes of a detected swipe gesture or non-swipe gesture, such as direction (e.g., forward, downward, up, and down) and swipe magnitude (e.g., full swipe or half swipe), a combination thereof, and the like.

In at least some embodiments, the detection component 312 further includes a data preprocessor 326 that preprocesses the sensors 310 before being obtained by the data analyzers 324. The preprocessor 326, in at least some embodiments, transforms the sensor data 322, such as electrical signals, into a digital format by implementing an analog-to-digital converter (ADC). The ADC samples the signal at a specific rate (sampling rate) and converts each sample into a digital value that represents the analog signal's intensity at that moment. The preprocessor 326 then generates one or more waveforms based on the digitized signals. In at least some embodiments, the preprocessor 326 performs one or more filtering operations to, for example, remove noise (e.g., background, speaker interference), remove frequencies lower than a cutoff frequency, a combination thereof, and the like. As an example, the speaker input waveform is subtracted from the microphone signal to mitigate speaker interference. The speaker's maximum frequency can also be capped at, for example, 20 kHz.

The preprocessor 326, in at least some embodiments, processes the sensor data 322 to obtain the Short-Time Fourier Transform (STFT) of one or more of the accelerometer data 322-1 or microphone data 322-2. STFT is a technique used to analyze the frequency content of signals that vary over time, such as those generated by an accelerometer 316 or microphone 116. The preprocessor 326 obtains the STFT for sensor data 322 by dividing a longer time signal into shorter segments of equal length and then computing the Fourier Transform for each segment. This process captures both the frequency and temporal information, providing a two-dimensional representation of the signal. In at least some embodiments, the preprocessor 326 represents the STFT as a spectrogram, which is a visual representation of the spectrum of frequencies of the signal as they vary with time. Each point in the spectrogram represents the intensity (often in terms of power or magnitude) of a particular frequency at a specific time. The preprocessor 326, in at least some embodiments, computes the log of the STFT to convert the accelerometer data 322-1 or microphone data 322-2 to the time-frequency domain. The STFT of the sensor data 322 extracts the high-frequency band information in the sensor data 322.

As described in greater detail below, the detection component 312, in at least some embodiments, implements one or more machine learning (ML) models, such as neural network (NNs) 328 managed by a neural network management component 330 to detect gestures, such as swipe gestures or non-swipe gestures, performed on the NED system 100. In at least some embodiments, one or more of the data analyzers 324 implement at least one of the neural networks 328 when analyzing the sensor data 322. The neural networks 328 take raw sensor data 322 or preprocessed sensor data 322 as input and output the set of detected gesture information 332.

In at least some embodiments, the processing device 300 further includes one or more neural network architectural configurations 334 (also referred to herein as “architectural configurations 334”). The neural network architectural configuration(s) 334 represents examples selected from a set of candidate neural network architectural configurations maintained by the processing device 300 (e.g., in the memory 308), another component of the NED system 100, or a system external to the NED system 100. Each neural network architectural configuration 334 includes one or more data structures having data and other information representative of a corresponding architecture and/or parameter configurations used by the neural network management component 330 to form a corresponding neural network 328 of the detection component 312. The information included in a neural network architectural configuration 334 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architectural configuration 334 includes any combination of neural network formation configuration elements (e.g., architecture and/or parameter configurations) for creating a neural network formation configuration (e.g., a combination of one or more neural network formation configuration elements) that defines and/or forms, for example, a deep neural network (DNN).

As described in greater detail below, the neural network training component 318 operates to manage the individual or joint training of neural networks 328 defined by the NN architectural configurations 334 using one or more sets of training data 336. The processing device 300, in at least some embodiments, implements the training data labeler component 320 to automatically label and generate at least some of the training data 336. After the training process has been completed, the neural network training component 318, in at least some embodiments, assesses the performance of the trained neural network 328 using a set of test data 338. In at least some embodiments, the neural network training component 318 stores or associates the parameters 340, such as weights and biases, learned by the neural network 328 during the training process with the NN architectural configuration 334 defining the neural network 328. In at least some embodiments, one or more of the NN architectural configurations 334, training data 336, test data 338, or parameters 340 are maintained by the processing device 300 in, for example, the memory 308. However, in other embodiments, one or more of these components are maintained or stored on a device or system external to the processing device 300. Also, in at least some embodiments, one or more of the training processes described herein are performed by a device or system external to the processing device 300. In at least some of these embodiments, the external system sends an indication to the processing device 300 of one or more selected NN architectural configurations 334 along with their associated learned parameters 340. The processing device 300 uses the received NN architectural configuration(s) 334, including the associated parameters 340, to implement one or more trained neural networks 328.

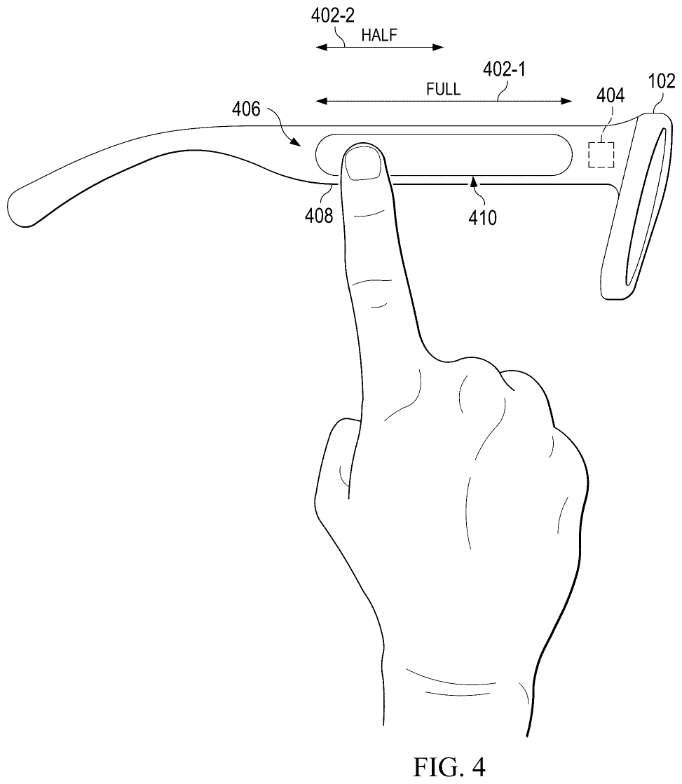

As described above, a user is able to provide gesture input to the NED system 100 by touching or coming into close contact with the NED system 100. In at least some embodiments, the detection component 312 operates to detect multiple different types of swipe gestures 402, such as a full swipe gesture 402-1 and a half swipe gesture 402-2, as illustrated in FIG. 4. These gestures 402 include, for example, a full backward swipe, a full forward swipe, a half backward swipe, a half forward swipe, and the like. An example of a full backward swipe is a swipe that starts close to a hinge 404 of the support structure 102 and ends towards the back 406 (e.g., near the user's ear) of a temple arm 408 of the support structure 102. An example of a full forward swipe is a swipe that starts from the back 406 of a temple arm 408 and ends around a hinge 404 of the support structure 102. An example of a half backward swipe is a swipe that starts from or close to the middle 410 of a temple arm 408 and ends towards the back 406 (e.g., near the user's ear) of the temple arm 408. An example of a half forward swipe is a swipe that starts from or close to the back 406 (e.g., near the user's ear) of a temple arm 408 and ends at or close to the middle 406 of the temple arm 408. Other examples of swipe gestures 402 detectable by the detection component 312 include, for example, a full upward swipe, a full downward swipe, a half upward swipe, and a half downward swipe. Also, in some instances, the swipe gestures 402 are performed in a diagonal direction compared to a horizontal or vertical direction.

In at least some embodiments, the detection component 312 is also configured to distinguish a swipe gesture from other on-device gestures, such as a tap, a double tap, and the like, based on one or more characteristics of the gestures, including directionality, duration, touch size area, and the like. For instance, when a user executes a swipe gesture, this action includes a directional aspect, such as left, right, upward, or downward. Conversely, when a user performs a tap gesture, this action lacks a directional component, as a tap gesture does not involve movement in specific directions. Also, a swipe gesture typically spans a longer duration than a tap gesture. Moreover, the touch area size of a swipe gesture is typically larger than the touch area size of a tap gesture. The detection component 312 identifies these differences in gesture characteristics to determine when a user's interaction with the NED system is a swipe gesture instead of another type of on-device gesture.

As described above, when a user performs a swipe (or non-swipe) gesture on the NED system 100, one or more of the sensors 310 transduce physical phenomena (e.g., sound waves, acceleration forces, vibrations, etc.) generated by the swipe gesture into electrical signals or a representation thereof. For example, when a user performs a swipe gesture on, for example, the temple arm 408 of the NED system 100, the accelerometer(s) 316 detects the specific movements and speed of the user's finger (or hand) as it swipes across the surface of the NED system 100. This motion generates distinct patterns of acceleration and deceleration, in addition to vibrations that occur as a result of the swipe, which the accelerometer 316 captures in real-time and stored as acceleration data 322-1. The microphone(s) 116 detects the subtle sound waves produced during the gesture as a result of, for example, friction between a surface of the NED system 100 and the user's finger (or hand). For example, as the user's finger (or hand) moves across the surface of the NED system 100, the finger disrupts the air and potentially makes contact with the device, creating distinctive sound waves. These sound waves vary in frequency, amplitude, and duration, depending on the speed, force, and nature of the swipe. The microphone 116, which is sensitive to these variations, converts the sound waves into electrical signals that accurately represent the acoustic signature of the swipe gesture. The electrical signals or a representation thereof are stored as microphone data 322-2. In at least some embodiments, different friction-enabling materials, coatings, or textures are applied to the temple arm 408 to enhance, change, or vary one or more of the vibrations or sound generated by a swipe gesture.

In at least some embodiments, the accelerometer data 322-1 includes not just the direction and velocity of the swipe but also any subtle variations in the gesture, allowing for a nuanced interpretation of the user's intent. For example, the accelerometer data 322-1 includes inertial characteristics of a swipe gesture, such as magnitude of acceleration, direction of acceleration, frequency of vibrations, amplitude of vibrations, temporal patterns, a combination thereof, and the like. The magnitude of acceleration data is a measurement of the intensity of the acceleration forces and indicates how quickly the velocity of the swipe gesture is changing in any direction. The direction of acceleration data includes information about the direction of the acceleration forces, which can be represented in three-dimensional space (x, y, and z axes) associated with the swipe gesture. This information helps determine the direction of the swipe gesture. The frequency and amplitude of the vibrations identify the rate at which these oscillations occur and their strength, which helps the detection component 312 distinguish between different types of gestures. The temporal patterns in the accelerometer data 322-1 indicate the timing and duration of acceleration and vibration events, enabling, for example, the identification of repetitive movements or gestures.

In at least some embodiments, the microphone data 322-2 includes acoustic characteristics of a swipe gesture, such as amplitude, frequency, phase, waveform shape, a combination thereof, and the like. The amplitude is indicative of the sound's loudness. Variations in amplitude within the electrical signal can distinguish louder sounds from softer ones. The frequency relates directly to the sound's pitch, with the signal's frequency changes reflecting those in the sound wave, thereby differentiating higher-pitched sounds from lower-pitched ones based on the speed at which the microphone's diaphragm vibrates in response to the sound waves. The phase of a sound wave captures its oscillation timing in relation to a fixed reference point, which helps determine how sound waves from a swipe gesture interact with each other. This interaction, influenced by the phase differences between overlapping sound waves, can affect the acoustic signature detected during gesture recognition. Understanding these phase relationships enables the detection component 312 to more accurately isolate and interpret the specific sounds of the swipe from background noise, enhancing the reliability of gesture detection by accounting for the way sounds combine or cancel each other out in the complex auditory environment around the NED system 100.

The inertial data analyzer 324-1 of the detection component 312 takes the accelerator data 322-1 as input, and the acoustic data analyzer 324-2 takes the microphone data 322-2 as input. In other embodiments, a single data analyzer 324 takes both types of sensor data 322 as input. In at least some embodiments, one or both of the accelerator data 322-1 or the microphone data 322-2 are preprocessed by the data preprocessor 326 of the detection component 312 before being provided to the data analyzers 324 as input. For example, as described above, the data preprocessor 326 obtains the STFT for one or both of the accelerator data 322-1 or microphone data 322-2, generates one or more waveforms representing each of the accelerator data 322-1 and microphone data 322-2, or a combination thereof. Also, as described above, the data preprocessor 326, in at least some embodiments, performs one or more filtering operations to, for example, remove noise, remove frequencies lower than a cutoff frequency, a combination thereof, and the like. As an example, given that a swipe gesture, in at least some instances, generates a high-frequency signal with ultrasonic information on both the IMU 314 (or accelerometer 316) and microphone 116, a high-pass filter is applied to the sensor data 322. For example, a high-pass filter with a cut-off frequency of 50 Hertz (Hz) is applied to the accelerometer data 322-1, although other cut-off frequencies are also applicable. In another example, a high-pass filter with a cut-off frequency of 1 kilohertz (kHz) or 20 kHz is applied to the microphone data 322-2, although other cut-off frequencies are also applicable.

When the inertial data analyzer 324-1 receives an input stream of accelerometer data 322-1 (either raw or preprocessed), the inertial data analyzer 324-1 analyzes this data 322-1 to identify the inertial characteristics or patterns of inertial characteristics indicative of a swipe gesture for the portion (window) of the accelerometer data 322-1 being analyzed. Similarly, when the acoustic data analyzer 324-2 receives an input stream of microphone data 322-2 (either raw or preprocessed), the acoustic data analyzer 324-2 analyzes this data 322-2 to identify the acoustic characteristics or patterns of acoustic characteristics indicative of a swipe gesture for the portion (window) of the microphone data 322-2 being analyzed. In at least some embodiments, the data analyzers 324 analyze the sensor data 322 using a sliding window W over the sensor input stream. The sliding windows W, in at least some embodiments, overlap each other.

Alternatively, or in addition to detecting a swipe (or non-swipe) gesture based on inertial or acoustic characteristics, the inertial data analyzer 324-1, in at least some embodiments, detects a swipe gesture from the accelerometer data 322-1 by identifying swipe gesture events or components within the accelerometer data 322-1 corresponding to the swipe gesture. A gesture footprint on an accelerometer signal is unique. For example, a swipe gesture event starts when a user's finger makes contact (an impact event) with a temple arm 408 of the support structure 102, which creates a peak in all three axes, similar to a tap gesture. The impact event is followed by the vibration (vibration event) generated by the act of swiping. The swipe gesture ends with a peak generated by a release event. These three consecutive sub-events generate a distinct footprint, which the inertial data analyzer 324-1 uses to detect the swipe gesture. Additionally, the rigid motion of the act of swiping helps the inertial data analyzer 324-1 determine the direction of the swipe.

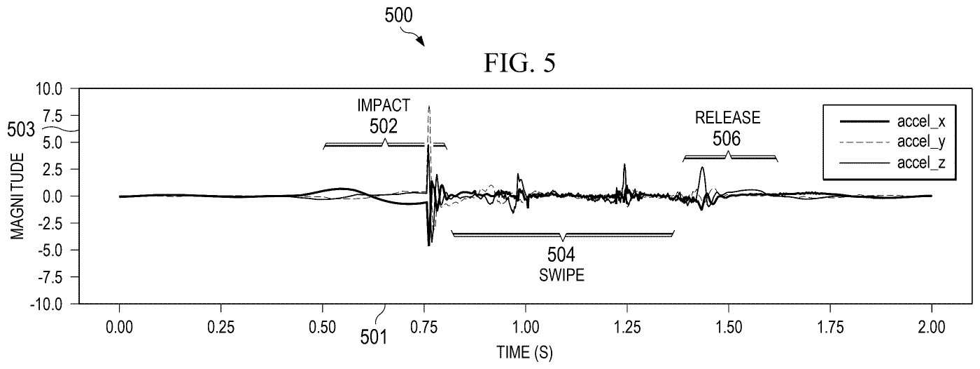

FIG. 5 shows an example of an accelerometer waveform 500 illustrating the components of a swipe gesture corresponding to the impact, swipe, and release events described above. In at least some embodiments, the accelerometer waveform 500 is included as part of or derived from the accelerometer data 322-1. In this example, time is represented by the x-axis 501, and the magnitude of the accelerometer waveform 500 is represented by the y-axis 503. As shown by the accelerometer waveform 500, a swipe gesture has components such as an impact 502 (e.g., start event), a vibrational swipe 504, a release 506 (e.g., end event), or other components related to the gesture's physical aspects. These components are represented in the accelerometer waveform 500 as a pattern of amplitude and frequency changes over time. These patterns reflect the dynamics of the swipe gesture, with each component exhibiting distinctive characteristics in the accelerometer waveform 500. For example, the impact 502, in at least some instances, appears as a sudden spike in amplitude, indicating the initial contact. The vibrational swipe 504, in at least some instances, is represented by fluctuations or a series of waves indicating the movement across a surface, reflecting variations in speed and pressure. The release 506, in at least some instances, appears as a rapid decrease in amplitude, marking the end of contact and completion of the swipe gesture. The impact 502, vibrational swipe 504, and release 506 collectively define a footprint or signature of the swipe gesture.

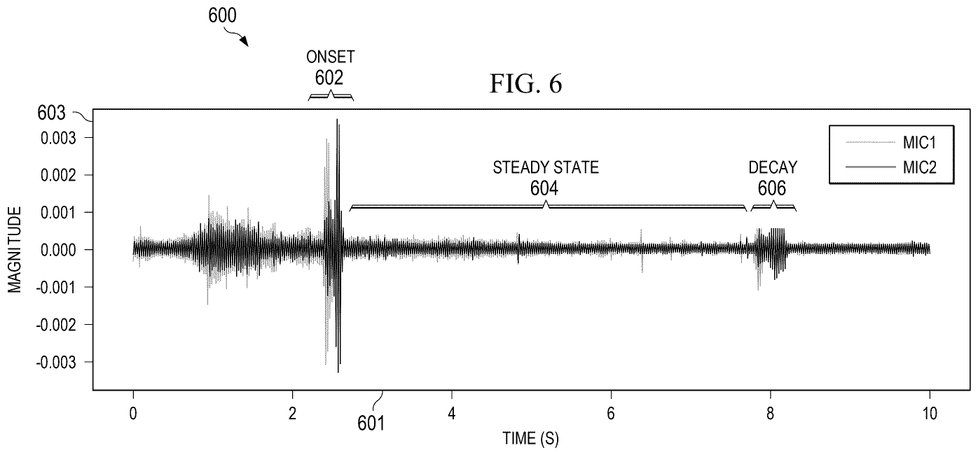

The acoustic data analyzer 324-2, in at least some embodiments, similarly detects a swipe (or non-swipe) gesture from the microphone data 322-2 by identifying swipe gesture events or components within the microphone data 322-2 corresponding to the swipe gesture. For example, FIG. 6 shows an example microphone waveform 600 illustrating the acoustic components of a swipe gesture. In at least some embodiments, the microphone waveform 600 is included as part of or derived from the microphone data 322-2. In this example, time is represented by the x-axis 601, and the magnitude of the microphone waveform 600 is represented by the y-axis 603. As shown by the microphone waveform 600, a swipe gesture has acoustic components such as an onset 602 (e.g., a start event), a steady state 604, a decay 606 (e.g., an end event), or other components related to the gesture's auditory aspects. These components are represented in the microphone waveform 600 as a pattern of amplitude and frequency changes over time. These patterns reflect the dynamics of the swipe gesture, with each component exhibiting distinctive characteristics in the microphone waveform 600. For example, the onset 602, in at least some instances, appears as a relatively sharp increase in amplitude from the baseline (silence or ambient noise level). This increase reflects the initial contact or the start of the motion, capturing the sound of the finger or object first moving against the surface. Following the onset 602, in at least some instances, the steady state 604 is represented as a relatively consistent sound amplitude (i.e., volume). The steady state 604 can include some fluctuations resulting from variations in the speed of the swipe, the texture of the surface being swiped, or the pressure applied. In this context, the steady state 604 encapsulates the continuous movement component of the swipe. The decay 606, in at least some instances, appears as a decrease in amplitude as the gesture slows down and eventually stops, returning to baseline levels.

The inertial data analyzer 324-1 and the acoustic data analyzer 324-2, in at least some embodiments, not only detect swipe (or non-swipe) gestures but also detect or identify gesture attributes, such as direction (e.g., forward, downward, up, and down) and swipe magnitude (e.g., full swipe or half swipe). For example, the inertial data analyzer 324-1 is able to determine gesture direction (e.g., forward, downward, up, and down) based on the direction of acceleration or the sign (positive or negative) and sequence of acceleration values along an accelerometer axis captured as part of the accelerometer data 322-1. The inertial data analyzer 324-1 and the acoustic data analyzer 324-2, in at least some embodiments, determine swipe magnitude (e.g., full swipe or half swipe) based on, for example, the duration of a swipe. For example, in at least some instances, a full swipe has a longer duration than a half swipe. The acoustic data analyzer 324-2 is able to determine gesture direction based on, for example, the order of the peaks in a microphone waveform.

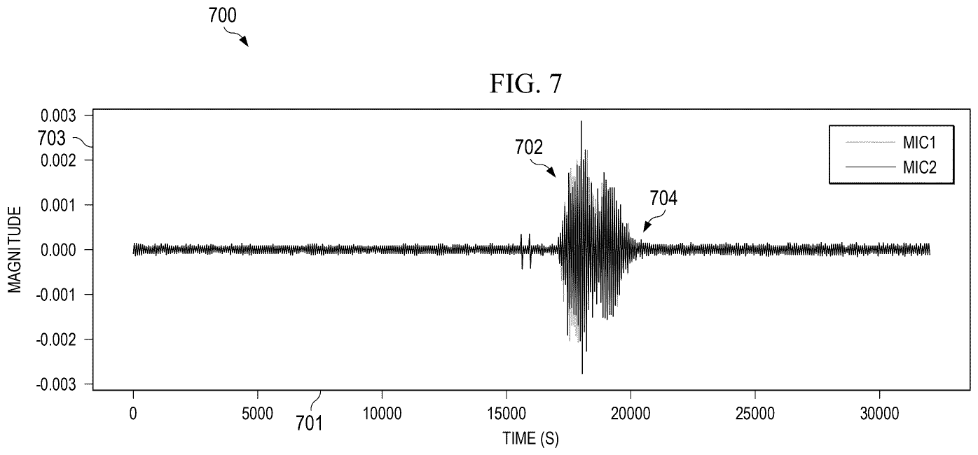

FIG. 7 shows an example microphone waveform 700 for a backward swipe gesture, and FIG. 7 shows an example microphone waveform 800 for a forward swipe gesture. Also, the microphone 116 that generated the waveforms 700 and 800 in these examples is located near the hinge 404 of the support structure 102 of the NED system 100. In these examples, the backward swipe started close to the hinge 404 and moved towards the back 406 (e.g., near the user's ear) of the temple arm 408, and the forward swipe started at the back 406 of the temple arm 408 and moved towards the hinge 404. Also, in these examples, time is represented by the x-axes 701 and 801, and magnitude is represented by the y-axes 703 and 803.

As shown in the waveform 700 for the backward swipe, the waveform 700 initially exhibits pronounced peaks 702 due to the gesture's proximity to the microphone 116, where the sound intensity, or pressure, is highest. This is a direct result of the sound source, which is the user's moving finger (or hand), being closest to the microphone 116, thus delivering a stronger signal. As the gesture continues and the distance between the source of the sound and the microphone 116 increases, the peaks within the waveform 700 correspondingly diminish in magnitude. This gradual reduction in peak heights is explained by the inverse square law of sound, which states that sound intensity decreases proportionally to the square of the distance from its source. Therefore, the waveform 700 transitions smoothly from higher peaks 702 to lower peaks 704, mirroring the swipe's continuous motion away from the microphone 116. This pattern is distinct from any background noise or echoes, which do not exhibit a systematic decrease in magnitude. As such, in at least some embodiments, when the inertial data analyzer 324-1 identifies a smooth or gradual transition from higher peaks 702 to lower peaks 704 in accelerometer data 322-1 based on the position of the microphone(s) 116, the inertial data analyzer 324-1 determines the swipe gesture is a backward swipe.

As shown in the waveform 800 for the forward swipe, the waveform 800 initially exhibits its lowest peaks 804, resulting from the user's finger (or hand) being furthest from the microphone 116. These minimal peaks 804 represent the lowest sound pressure levels being captured, as the sound energy produced by the forward swipe has to travel the greatest distance to reach the microphone 116. The intensity of sound decreases with the square of the distance from its source (e.g., the user's finger), according to the inverse square law, which explains why the sound is faintest when the swipe starts far away. As the forward swipe advances towards the microphone 116, the distance between the sound source and the microphone 116 decreases. Consequently, the sound pressure levels captured by the microphone 116 increase, and the waveform 800 transitions smoothly from lower peaks 804 to higher peaks 802, mirroring the swipe's continuous motion toward the microphone 116. This pattern is distinct from any background noise or echoes, which do not exhibit a systematic decrease in magnitude. As such, in at least some embodiments, when the acoustic data analyzer 324-2 identifies a smooth or gradual transition from lower peaks 804 to higher peaks 802 in microphone data 322-2 and based on the position of the microphone(s) 116, the acoustic data analyzer 324-2 determines the swipe gesture is a forward swipe.

As a result of their analysis, one or both of the inertial data analyzer 324-1 or the acoustic data analyzer 324-2 output a set of detected gesture information data 332. This gesture information 332 indicates that, for a given portion or window of sensor data 322, a gesture was detected, a gesture was not detected, a detected gesture is a swipe gesture, a detected gesture is another type of gesture, attributes of a detected swipe gesture such as direction (e.g., forward, downward, up, and down), swipe magnitude (e.g., full swipe or half swipe), and swipe speed, a combination thereof, or the like. In response to a detected swipe gesture and its attributes, a variety of actions can be initiated at the NED system 100 by one or more components, such as the processor 302. For instance, a first type of swipe gesture can be used to navigate through different menus or to scroll through a list of items, such as messages, applications, or notifications. A second type of swipe gesture can adjust settings such as volume or brightness. A detected swipe gesture, in at least some embodiments, also enables more complex interactions within specific applications, such as panning the view of a map or rotating a three-dimensional model. In gaming or interactive storytelling, a detected swipe gesture can trigger actions within the game world, such as jumping, crouching, running, or selecting items. A detected swipe gesture can also be combined with other forms of input, such as voice commands or head movements, to perform more sophisticated tasks or to access deeper levels of functionality. In at least some embodiments, the image source of the NED system 100 is controlled in response to detecting the swipe gesture to perform one or more of the actions described above. It should be understood that other actions are also applicable.

In at least some embodiments, the detection component 312 implements one or more of the neural networks 328 when performing the gesture detection techniques described above. The neural networks 328, in at least some embodiments, are deep neural network(s) (DNNs) including convolutional neural networks (CNNs). However, examples of other applicable DNNs include recurrent neural networks (RNNs), long short-term memory (LSTM) networks, gated recurrent unit (GRU) networks, time-delay neural networks (TDNNS), and the like. The neural networks 328 are individually or jointly trained to process the sensor data 322, including one or more of accelerometer data 322-1 and microphone data 322-2, to make an inference whether a swipe (or non-swipe) gesture has occurred. The neural networks 328, in at least some embodiments, are further trained to infer attributes of a detected gesture, such as direction (e.g., forward, downward, up, and down), swipe magnitude (e.g., full swipe or half swipe), and swipe speed, a combination thereof, or the like. In at least some embodiments, one or more separate neural networks 328 are implemented to process each different type of sensor data 322 (e.g., accelerometer data 322-1 and microphone data 322-2). However, in other embodiments, a single neural network 328 is implemented to process multiple different types of sensor data 322 (e.g., accelerometer data 322-1 and microphone data 322-2).

The neural networks 328, in at least some embodiments, are trained by the NN training component 318 implemented at the processing device 300. However, in other embodiments, the neural networks 328 are trained by a system that is remote or external to the NED system 100. The NN training component 318 operates to manage the individual or joint training of the neural networks 328 defined by the architectural configurations 334 for a set of candidate neural networks 328 available to be employed at the processing device 300 using one or more sets of training data 336. The training, in at least some embodiments, includes training one or more neural networks 328 defined by an architectural configuration(s) 334 while offline (that is, while not actively engaged in processing the sensor data 322, detecting swipe gesture, or detecting swipe gesture attributes) and/or online (that is, while actively engaged in processing the sensor data 322, detecting swipe gesture, or detecting swipe gesture attributes). For example, the NN training component 318 can individually (or jointly) train one or more neural networks 328 defined by an NN architectural configuration(s) 334 using one or more sets of training data 336 to provide swipe gesture and swipe gesture attribute detection functionality. In at least some embodiments, the NN training component 318 further trains the neural networks 328 to perform the swipe gesture detection (and swipe gesture attribute detection) while satisfying one or more key performance indicators (KPIs) or thresholds, such as a Recall at a fixed False Positives per Minute (Recall@FPM).

As part of the training process, the NN training component 318 selects a suitable loss function, such as cross-entropy for classification tasks, and an optimizer, such as Adaptive Moment Estimation (Adam) or Stochastic Gradient Descent (SGD), to minimize this loss. Training the network involves feeding batches of data through the neural network 328 and using, for example, backpropagation to update the weights based on the gradient of the loss function. Techniques, such as early stopping, are employed to halt training when the validation loss stops decreasing, and checkpoints are saved regularly to allow the best-performing model to be recovered. It should be understood that other training processes or techniques are also applicable.

During training, the neural network 328 defined by an architectural configuration 334, in at least some embodiments, adaptively learns based on supervised learning. In supervised learning, the neural network 328 receives various types of input data as training data 336. The neural network processes the training data 336 to learn how to map the input to a desired output. As one example, the neural network 328 receives training data 336 including sensor data, such as accelerometer data and microphone data. In at least some embodiments, the training sensor data is preprocessed to ensure the data is in a form suitable for training. For example, the training sensor data is filtered to remove noise or unwanted frequencies, transformed to the time-frequency domain, a combination thereof, and the like. In at least some embodiments, if both accelerometer data and microphone data are being used for training a single neural network, one or more normalization operations are performed to normalize the accelerometer data and microphone data to a common scale.

The training accelerometer data includes, for example, patterns of acceleration and deceleration, in addition to vibrations that occur as a result of a swipe gesture. The training accelerometer data further includes, for example, inertial characteristics of a swipe gesture, such as magnitude of acceleration, direction of acceleration, frequency of vibrations, amplitude of vibrations, temporal patterns, a combination thereof, and the like. In another example, the training accelerometer data also includes accelerometer waveforms that represent a swipe gesture, non-swipe gestures, background noise, a combination thereof, and the like. The training microphone data includes, for example, patterns of frequency, amplitude, and duration that occur as a result of a swipe gesture. The training microphone data further includes, for example, acoustic characteristics of a swipe gesture such as amplitude, frequency, phase, waveform shape, a combination thereof, and the like. In another example, the training microphone data also includes microphone waveforms that represent a swipe gesture, non-swipe gestures, background noise, a combination thereof, and the like.

In at least some embodiments, the training accelerometer data and training microphone data are known or labeled data such that the neural network 328 being trained is able to identify the instances of this training data representing a swipe gesture, a non-swipe gesture, background noise, and the like. Also, in at least some embodiments, the characteristics and attributes of a swipe gesture, non-swipe gesture, or background noise are also labeled. For example, an accelerator waveform (or a portion thereof) representing a swipe gesture is labeled with timestamps indicating the start and end of a swipe gesture in the waveform. In at least some embodiments, components of a swipe gesture, such as an impact, a vibrational swipe, and a release, are also labeled within the accelerator waveform. In another example, a microphone waveform (or a portion thereof) representing a swipe gesture is similarly labeled with timestamps indicating the start and end of a swipe gesture in the waveform. In at least some embodiments, acoustic components of a swipe gesture, such as an onset, a steady state, and a decay, are also labeled within the waveform. The training data, in at least some embodiments, is also labeled to identify gesture attributes, such as direction (e.g., forward, downward, up, and down) and swipe magnitude (e.g., full swipe or half swipe).

In at least some embodiments, the NN training component 318 (or another component of the processing device 300) implements a training data labeling component 320, as described above. The training data labeling component 320, in at least some embodiments, is a heuristic automatic labeler that generates the labels for the training data 336, such as the labels described above. For example, the training data labeling component 320 obtains input sensor data 322, such as raw accelerometer signals, raw microphone signals, or a combination thereof, and applies a filter, such as a first-order Infinite Impulse Response (IIR) filter, to the input sensor data to remove low-frequency (e.g., below 50 Hz, 1 kHz, 20 kHz, etc.) artifacts. The training data labeling component 320, in at least some embodiments, performs principal component analysis (PCA) to reduce the filtered signal to one dimension and then performs a Fast Fourier Transform (FFT) to transform the signal to the time-frequency domain. After applying another filter, such as a Gaussian filter, to smooth the transformed signal, the training data labeling component 320 calculates the mean of high-frequency bands and finds the local maxima. The training data labeling component 320 uses the identified local maxima to generate labels, such as the start and end events of a swipe gesture, for the training sensor data.

The NN training component 318 (or another component of the processing device 300), in at least some embodiments, generates the training data 336 based on sensor data (e.g., accelerometer data and microphone data) labeled by the training data labeling component 320, humans, or a combination thereof. In at least some embodiments, the NN training component 318 implements a sliding window approach in which the NN training component 318 simplifies swipe detection to a classification problem where a sensor input window S is mapped to a gesture probability vector G that includes all the possible gestures and a background (or idle) class. The NN training component 318 uses a sliding window W (e.g., 1000 milliseconds) with a stride (e.g., 18 milliseconds) over the training sensor input stream and determines its gesture probability vector based on the following process. For example, the NN training component 318 processes the labeled training sensor input data for each processing window (or analyzing window) C of a plurality of windows and identifies the closest labeled gesture event G with an end timestamp of E. If the end timestamp E of the window C is within the time interval defined by [E+pad, E+pad+perturb], then the detection component identifies and uses C as a positive training sample of G. Otherwise, if the end timestamp E of the window Cis outside of the time interval, the NN training component 318 identifies and uses C as a training sample for background (idle class). Here, the pad is an amount of time (e.g., 60 milliseconds) that is added to the end timestamp E to include any post-event contextual information and to help mitigate any human error in labeling, and perturb is an amount of time (e.g., 60 milliseconds) added after the pad to help with model robustness.

The neural network 328 analyzes the training data input using its nodes and generates a corresponding output. The NN training component 318 compares the corresponding output to truth data to assess the performance of the neural network 328, using metrics such as accuracy, precision, recall, F1 score, a combination thereof, and the like. The NN training component 318 adapts the algorithms implemented by nodes of the neural network 328 to improve the accuracy of the output data. In at least some embodiments, the NN training component 318 also performs hyperparameter tuning using methods, such as grid search or random search, to find the optimal settings for the neural network 328. The neural network 328 may also undergo further refinements based on the results of this evaluation, which involve, for example, additional training, adjustments to the network architecture, or the introduction of new data augmentation strategies to improve the network's ability to accurately detect swipe gestures.

As a result of the training process, a neural network 328 is trained to recognize patterns in the input signals or waveforms indicative of a swipe gesture to accurately detect when a swipe gesture is performed on the NED system 100 and the type of swipe gesture that was performed, such as a full backward swipe, a full forward swipe, a half backward swipe, a half forward swipe, and the like. For example, the neural network 328 is trained to recognize or identify the inertial characteristics or patterns of inertial characteristics indicative of a swipe gesture for the portion (window) of accelerometer data 322-1 being analyzed. Similarly, the neural network 328 (or another neural network) is trained to recognize or identify the acoustic characteristics or patterns of acoustic characteristics indicative of a swipe gesture for the portion (window) of microphone data 322-2 being analyzed. In at least some embodiments, similar processes are performed to train a neural network 328 to detect non-swipe gestures.

After the training process has been completed, the NN training component 318, in at least some embodiments, assesses the performance of the trained neural network using a set of test data 338. In at least some embodiments, the NN training component 318 stores or associates the parameters 340, such as weights and biases, learned by the neural network 328 during the training process with the neural network architectural configuration 334 defining the neural network 328. If an external system performs the training, the external system, in at least some embodiments, sends an indication to the processing device 300 of one or more selected neural network architectural configurations 334 along with their associated learned parameters 340. The processing device 300 uses the received neural network architectural configuration(s) 334, including the associated parameters 340, to implement one or more trained neural networks 328.

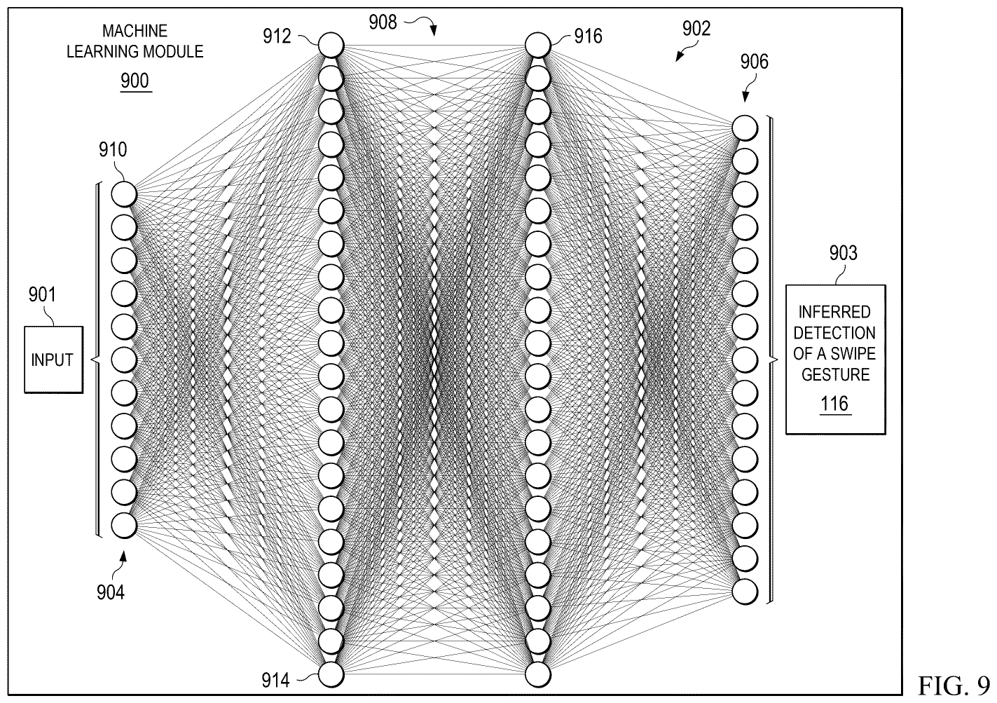

FIG. 9 illustrates an example of a machine learning (ML) module 900 for implementing a neural network 328 in accordance with at least some embodiments. For example, FIG. 9 illustrates the ML 900 implementing a neural network to detect swipe (or non-swipe) gestures using one or both of inertial sensor data or acoustic sensor data at the NED system 100. The ML module 900, in at least some embodiments, is implemented by (or replaces) one or both of the inertial data analyzer 324-1 and an acoustic data analyzer 324-2. In at least some embodiments, the data analyzers 324 implement separate ML modules 900 or the same ML module 900.

In the depicted example, the ML module 900 implements at least one neural network 328, such as DNN 902, with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based on adaptive learning. Using the DNN 902, the ML module 900 performs a variety of different types of analysis, including single linear regression, multiple linear regression, logistic regression, stepwise regression, binary classification, multiclass classification, multivariate adaptive regression splines, locally estimated scatterplot smoothing, and so forth.

In the depicted examples, the DNN 902 includes an input layer 904, an output layer 906, and one or more hidden layers 908 positioned between the input layer 904 and the output layer 906. Each layer has an arbitrary number of nodes, where the number of nodes between layers can be the same or different. That is, the input layer 904 can have the same number and/or a different number of nodes as output layer 906, the output layer 906 can have the same number and/or a different number of nodes than the one or more hidden layer 908, and so forth.

Node 910 corresponds to one of several nodes included in input layer 904, wherein the nodes perform separate, independent computations. A node receives input data and processes the input data using one or more algorithms to produce output data. Typically, the algorithms include weights and/or coefficients that change based on adaptive learning. Thus, the weights and/or coefficients reflect information learned by the neural network 328. For example, in at least some embodiments, the nodes in the input layer 904 receive input. Each node 912 in the hidden layer 908 receives inputs from all nodes in the previous layer. Each input is multiplied by a corresponding weight, which is a measure of the input's importance in determining the node's output. All the weighted inputs at a node in the hidden layer 908 are summed together, along with a bias term, which is similar to the intercept in a linear regression model. The sum is then passed through an activation function, which introduces non-linearity into the model, allowing the model to learn and represent more complex patterns. Examples of activation functions include a sigmoid function, a hyperbolic tangent function (tanh), a Rectified Linear Unit (ReLU), and the like. The output of the activation function is the output of the node. The outputs of all nodes in a hidden layer 908 serve as the inputs to the nodes in the next layer. This continues layer by layer until the output layer 906 is reached. Also, each node in a layer can, in some cases, determine whether to pass the processed input data to one or more next nodes. To illustrate, after processing input data, node 910 can determine whether to pass the processed input data to one or both of node 912 and node 914 of the hidden layer 908. Alternatively, or additionally, node 910 passes the processed input data to nodes based upon a layer connection architecture. This process can repeat throughout multiple layers until the DNN 902 generates an output 903, such as an inferred detection of a swipe (or non-swipe) gesture, using the nodes (e.g., node 916) of output layer 906.

As described above, a neural network 328 can also employ a variety of architectures 334 that determine what nodes within the neural network 328 are connected, how data is advanced and/or retained in the neural network 328, what weights and coefficients the neural network 328 is to use for processing the input data, how the data is processed, and so forth. These various factors collectively describe a neural network architectural configuration 334, such as the neural network architectural configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architectural configuration 334 can include a variety of parameter configurations that influence how the DNN 902 or other neural network processes input data.

An architectural configuration 334 of a neural network 328 can be characterized by various architecture and/or parameter configurations. To illustrate, consider an example in which the DNN 902 implements CNN. Generally, a CNN corresponds to a type of DNN in which the layers process data using convolutional operations to filter the input data. Accordingly, the CNN architectural configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively, or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer and using the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively, or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In at least some embodiments, the weights and biases are learned parameter configurations, such as parameter configurations generated from training data. A layer parameter specifies layer connections and/or layer types, such as a fully connected layer type that indicates to connect every node in a first layer (e.g., output layer 906) to every node in a second layer (e.g., hidden layer 908), a partially-connected layer type that indicates which nodes in the first layer to disconnect from the second layer, an activation layer type that indicates which filters and/or layers to activate within the neural network, and so forth. Alternatively, or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architectural configuration 334 can include any suitable type of configuration parameter that a DNN can apply that influences how the DNN processes input data to generate output data.

The architectural configurations 334 of the ML module 900, in at least some embodiments, is based on the type of swipe (or non-swipe) gesture being detected (e.g., a full backward swipe, a full forward swipe, a full upward swipe, a full downward swipe, a half backward swipe, a half forward swipe, a half upward swipe, a half downward swipe type, a combination thereof, and the like), the type of sensor data 322 being processed (e.g., inertial data, including accelerometer data 322-1, or acoustic data, including microphone data 322-2), a combination thereof, and the like. In at least some embodiments, the architectural configurations 334 of the ML module 900 are also based on whether directionality is to be considered for a swipe gesture. For example, in at least some embodiments, one or more architectural configurations 334 are configured to define a non-directional neural network(s) 328, implementing binary classification that detects swipes, including full and half swipes or an idle state. One or more other architectural configurations 334 are configured that define a directional neural network(s) 328 that detects swipes and their directionality (e.g., forward, backward, up, down, etc.).

In at least some embodiments, the device implementing the ML module 900 locally stores some or all of a set of candidate neural network architectural configurations 334 that the ML module 900 can employ. For example, a component can index the candidate neural network architectural configurations by a look-up table (LUT) or other data structure that takes as inputs one or more parameters, such as sensor data type, and outputs an identifier associated with a corresponding locally stored candidate neural network architectural configuration 334 that is suited for operation in view of the input parameter(s). In other embodiments, it can be more efficient or otherwise advantageous to have a remote or external system operate to select the appropriate neural network architectural configurations 334 to be employed in ML module 900. In this approach, the external system obtains information representing some or all of the parameters that can be used in the selection process from the processing device 300 and, from this information, selects a neural network architectural configuration(s) 334 from a set of such configurations maintained at the external system. The external system, in at least some embodiments, implements this selection process using, for example, one or more algorithms, a LUT, and the like. The external system then transmits to the processing device 300 either an identifier or another indication of the neural network architectural configuration 334 selected for the ML module(s) 900 or, in configurations where the processing device 300 has a locally stored copy, the external device transmits one or more data structures representative of the neural network architectural configuration 334 selected for the processing device 300.

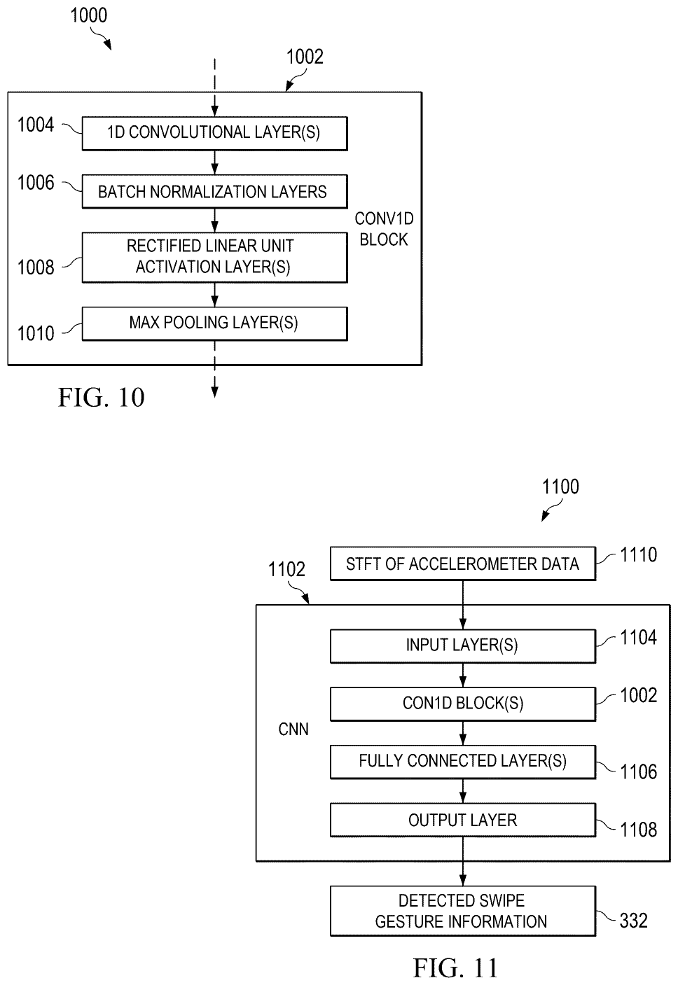

As described above, in at least some embodiments, the neural network 328 implemented by the detection component 312 is a CNN. FIG. 10 shows one example of an architecture 1000 for a CNN 1002 (also referred to herein as “a Conv1D block 1002”. In this example, the architecture 1000 of the CNN 1002 for processing sensor data 322, such as accelerometer data 322-1 or microphone data 322-2, includes a one-dimensional (1D) convolutional layer(s) 1004, a batch normalization (BN) layer(s) 1006, a rectified linear unit (ReLU) activation layer(s) 1008, and a max pooling layer(s) 1010. The input to this CNN 1002, in at least some embodiments, is accelerometer data 322-1 or microphone data 322-2 in the time domain. The convolutional layer 1004 applies convolution operations to extract temporal features from input sequences. Stated differently, the convolutional layer 1004 is responsible for scanning through the input sequence and identifying local patterns. The convolutional layer 1004 does this by applying multiple filters (or kernels) across the sequence, where each filter is designed to detect a specific feature or pattern at various positions along the input. The output of this layer 1004 is a set of feature maps, each corresponding to the response of the input sequence to one of the filters, effectively transforming the original data into a higher-level representation of detected features.

The BN layer 1006 normalizes the output of the previous layer (e.g., the convolutional layer 1004) by adjusting and scaling the activations to have a mean of zero and a variance of one. This normalization process helps stabilize the learning process, speeds up the training of neural networks by reducing the number of epochs needed to train, and also provides some regularization effect, potentially reducing overfitting. The statistics learned during the training stage are then fixed and used during the inference phase, ensuring consistent performance across different stages. The ReLU layer 1008 implements an activation function that introduces non-linearity into the network without affecting the receptive fields of the convolution layer 1004. The ReLU layer 1008 works by, for example, replacing all negative values in the input feature maps with zero, promoting sparsity in the activations, and allowing the network to learn complex patterns more effectively. The max pooling layer 1010 reduces the dimensionality of the feature maps, both to decrease the computational load for the subsequent layers and to make the detection of features invariant to small shifts and distortions in the input sequence. By taking the maximum value over a window sliding across each feature map, max pooling extracts the most prominent features, thereby reducing the sensitivity of the output to the exact location of features in the input.

FIG. 11 shows another example of an architecture 1100 for a CNN 1102. In this example, the architecture 1100 of the CNN 1102 for processing sensor data 322, such as accelerometer data 322-1 or microphone data 322-2, includes one or more input layers 1104, one or more of the Conv1D blocks 1002 of FIG. 10, one or more fully connected (FC) layers 1106, and an output layer 1108. The input to the CNN 1102, in at least some embodiments, is accelerometer data 322-1 that has been transformed to the time-frequency domain. For example, the input, in at least some embodiments, is the STFT 1110 of the accelerometer data 322-1.

The input layer 1104 is the initial layer where data is introduced into the CNN 1102. This layer 1104 passes the input data, such as the STFT 1110 of the accelerometer data 322-1, to the next layer. The Conv1D blocks 1002 have been described above with respect to FIG. 10. The one or more FC layers 1106 are neural network layers where every input neuron is connected to every output neuron. One role of the FC layer 1106 is to interpret the features extracted by the Conv1D block(s) 1002 in the context of the task at hand (e.g., classification). The FC layer(s) 1104 is able to learn non-linear combinations of the high-level features extracted by the convolutional layers, contributing to the network's ability to make sense of the input data in a more abstract and comprehensive manner. The output layer 1108 is tailored to the specific task. For classification tasks, this layer, in at least some embodiments, includes a softmax activation function that converts the outputs of the FC layers 1106 into probabilities, with each neuron corresponding to a class label. The neuron with the highest probability indicates the informed class, such as a swipe, idle, non-swipe, full backward swipe, a full forward swipe, a full upward swipe, a full downward swipe, a half backward swipe, a half forward swipe, a half upward swipe, or a half downward swipe type. The output of the CNN 1102, in at least some embodiments, is stored as part of the detected gesture information 332.

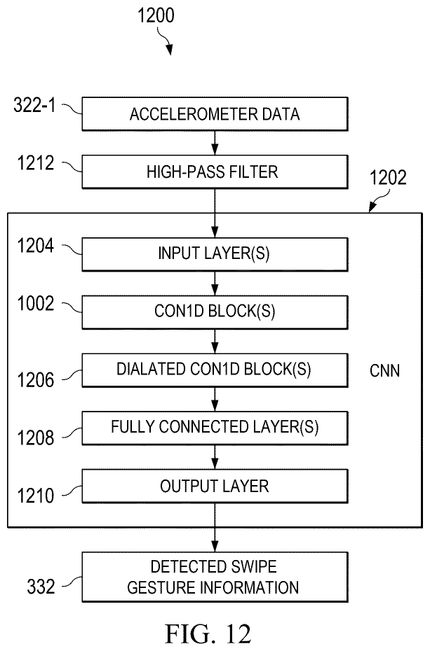

FIG. 12 shows another example of an architecture 1200 for a CNN 1202. In this example, the CNN 1202 is a temporal convolutional neural network (TCN). The architecture 1200 of the CNN 1202 for processing sensor data 322, such as accelerometer data 322-1 or microphone data 322-2, includes one or more of the Conv1D blocks 1002 of FIG. 10, one or more input layers 1204, one or more dilated Conv1D blocks 1206, one or more fully connected (FC) layers 1208, and an output layer 1210. The input to the CNN 1102, in at least some embodiments, is sensor data 322, such as raw accelerometer data 322-1, which is in the time domain. In at least some embodiments, the input sensor data 322 is filtered by a high-pass filter 1212, such as a second-order high-pass filter, which can be a hyper-parameter for the CNN 1202.

The input to the CNN 1102, in at least some embodiments, is time-domain data, such as raw accelerometer data 322-1, that has been filtered by a high-pass filter 1212, such as a second-order high-pass filter, which can be a hyper-parameter for the CNN 1202. The input layer 1204 is the initial layer where data is introduced into the CNN 1202. This layer 1204 passes the input data, such as the raw accelerometer data 322-1, to the next layer. The Conv1D blocks 1002 have been described above with respect to FIG. 10. The dilated Conv1D blocks 1206 extend the convolutional layers of the Conv1D blocks 1002 by introducing dilation rates to the convolution operation. This means that the filter is applied over an area larger than its length by skipping input values at a certain rate. Dilated convolutions allow the CNN 1202 to aggregate information over a larger context without increasing the number of parameters or the amount of computation significantly. The FC layers 1208 and the output layer 1210 are similar to those described above with respect to FIG. 11. As such, the Conv1D block 1002 and the dilated Conv1D blocks 1206 extract and process local and global features, respectively, the FC layer(s) 1208 integrates these features into meaningful representations, and the output layer 1210 maps these representations to specific task outcomes, enabling the CNN 1202 to make informed classifications based on the input accelerometer data 322-1. The informed classifications (i.e., the output of the CNN 1202) are a classification of a gesture, such as a swipe, idle, non-swipe gesture, a full backward swipe, a full forward swipe, a full upward swipe, a full downward swipe, a half backward swipe, a half forward swipe, a half upward swipe, or a half downward swipe type. This output, in at least some embodiments, is stored as part of the detected gesture information 332.

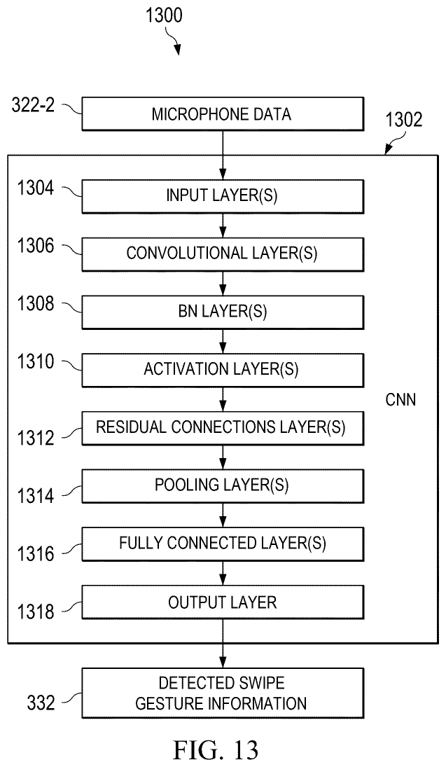

FIG. 13 shows an example of an architecture 1300 for a CNN 1302 for processing microphone data 322-2. In this example, the CNN 1302 is a temporal convolutional neural network (TCN). The architecture 1300 of the CNN 1302 includes one or more input layers 1304, one or more convolutional layers 1306, one or more BN layers 1308, one or more activation layers 1310, one or more residual connections 1312, one or more pooling layers 1314, one or more FC layers 1316, and an output layer 1322. The input to the CNN 1302, in at least some embodiments, is microphone data 322-2. The microphone data 322-2, in at least some embodiments, is transformed into the time-frequency domain by computing the STFT of the microphone data 322-2. Also, in at least some embodiments, microphone data 322-2 from multiple microphones 116 is provided as input to the CNN 1302. In at least some of these embodiments, the STFT is computed for each set of microphone data 322-2, which are then stacked. Stacking the STFTs of the data 322-2 from multiple microphones 116 involves combining these frequency-time representations into a single, unified structure. For example, the STFT data from one microphone 116-1 is appended to that of the other microphone 116-2 in a way that retains the time alignment but expands the frequency information. This stacking process leverages the spatial information captured by the physical separation of the two microphones 116. The stacked input microphone data 322-2 enables the CNN 1302 to extract a wide range of information, such as the direction of an incoming sound to or distinguishing between multiple sound sources.

The input layer 1304 is the initial layer where data is introduced into the CNN 1302. This layer 1304 passes the input data, such as the microphone data 322-2, to the next layer. The convolutional layers 1306, BN layers 1308, activation layers 1310, pooling layers 1314, and FC layers 1316 are similar to those described above with respect to FIG. 10 to FIG. 12. The residual connections 1312 allow for the direct flow of information across different layers by bypassing one or more layers and adding the input directly to the output of a layer or block of layers. These connections 1312 help alleviate the vanishing gradient problem by facilitating better gradient flow during backpropagation and ensure that deeper layers can at least perform as well as shallower ones by learning identity functions. The output layer 1322, in at least some embodiments, implements a normalized exponential function, such as softmax activation, that generates a probability distribution over potential classes, representing the CNN's inferences based on the temporal patterns learned throughout the CNN. The output layer 1322 outputs one or more classifications of the input microphone data 322-2, such as an indication of a swipe gesture, idle, a non-swipe gesture, a full backward swipe, a full forward swipe, a full upward swipe, a full downward swipe, a half backward swipe, a half forward swipe, a half upward swipe, or a half downward swipe type. This output, in at least some embodiments, is stored as part of the detected gesture information 332.

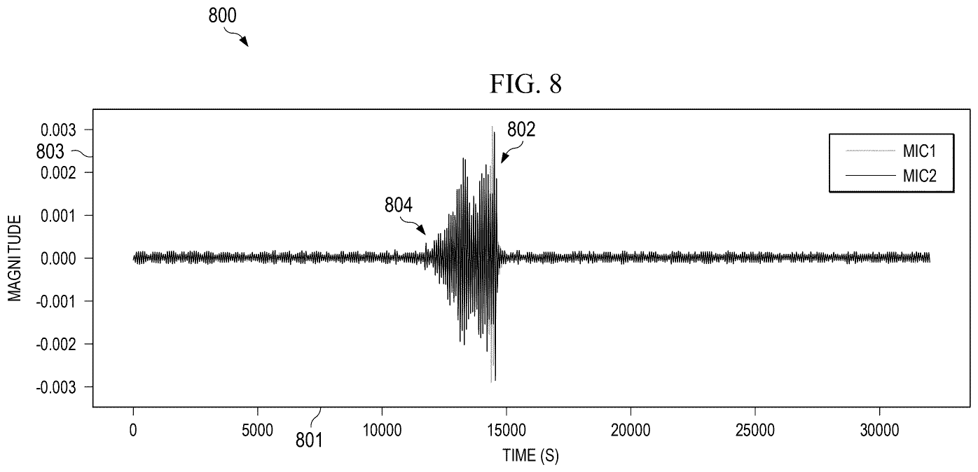

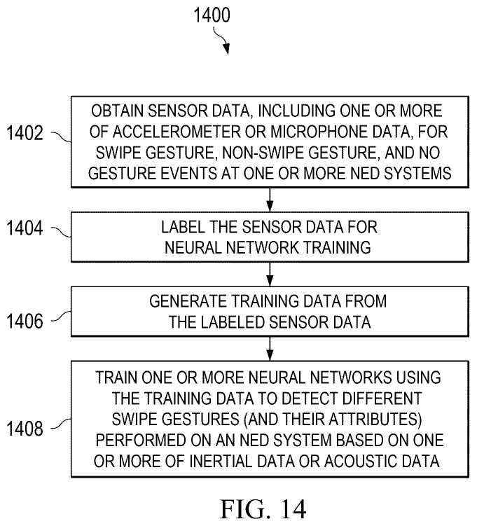

FIG. 14 is a diagram illustrating an example method 1400 of training one or more neural networks for detecting gestures, such as swipe gestures, non-swipe gestures, or a combination thereof, performed on an NED system 100 based on at least one of inertial sensor data or acoustic sensor data in accordance with at least some embodiments. The processes described below with respect to method 1400 have been described above in greater detail with reference to FIG. 1 to FIG. 13. It should be understood that method 1400 is not limited to the sequence of operations shown in FIG. 14, as at least some of the operations can be performed in parallel or in a different sequence. Moreover, in at least some embodiments, method 1400 can include one or more different operations than those shown in FIG. 14.

At block 1402, the training component 318 (or a system external to the NED system 100) obtains a first set of sensor data 322 generated by one or more sensors 310 at an NED system(s) in response to one or more of swipe gesture, non-swipe gesture, or no gesture events at the NED system(s). As described above, the sensors 310 include microphones 116, IMUs 314, individual accelerometers, individual gyroscopes, individual magnetometers, and the like. The first set of sensor data 322 includes inertial sensor data such as accelerometer data 322-1, acoustic sensor data such as microphone data 322-2, a combination thereof, and the like. The first set of sensor data 322 is different from a second set of sensor data 322 that is input to the neural network 328 after training to detect swipe gestures at the NED system 100.

At block 1404, at least a portion of the first set of sensor data 322 is labeled. As described above, in at least some embodiments, the first set of sensor data 322 is automatically labeled by the training data labeling component 320. In these embodiments, the training data labeling component 320 applies a filter, such as a first-order Infinite Impulse Response (IIR) filter, to the first set of sensor data 322 to remove low-frequency artifacts. The training data labeling component 320 performs PCA to reduce the first set of sensor data 322, which has been filtered, to one dimension and then performs an FFT to transform the first set of sensor data 322 to the time-frequency domain. The training data labeling component 320, in at least some embodiments, applies another filter, such as a Gaussian filter, to smooth the first set of sensor data 211, which has been transformed to one-dimension and filtered. The training data labeling component 320 then calculates the mean of high-frequency bands, finds the local maxima, and uses the identified local maxima to generate labels, such as the start and end events of a swipe gesture, for the first set of sensor data 322, which has been transformed to one-dimension and filtered.

At block 1406, the NN training component 318 generates training data 336 based on the labeled first set of sensor data 322. As described above, the NN training component 318 maps a sensor input window S to a gesture probability vector G that includes all the possible gestures and a background (or idle) class. The NN training component 318 uses a sliding window W over the labeled first set of sensor data 322 stream and determines its gesture probability vector. For example, the NN training component 318 processes the labeled first set of sensor data 322 for each window C and identifies the closest labeled gesture event G with an end timestamp of E. If end timestamp E of the window C is within the interval defined by [E+pad, E+pad+perturb], then the NN training component 318 identifies and uses C as a positive training sample of G. Otherwise, the NN training component 318 identifies and uses C as a training sample for background (idle class).

At block 1408, the NN training component 318 trains one or more neural networks 328 using the training data 336, as described above. For example, the NN training component 318 trains one or more neural networks 328 to detect different types of swipe gestures and their attributes, such as direction and magnitude, performed on an NED system 100 based on sensor data 322, such as inertial data, acoustic data, or a combination thereof.

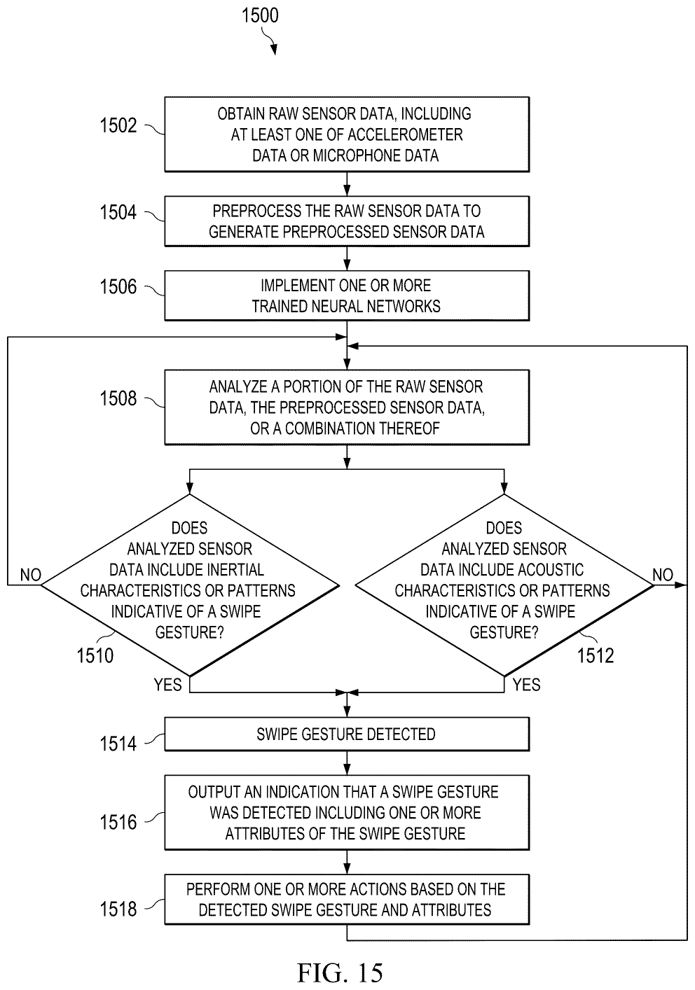

FIG. 15 is a diagram illustrating an example method 1500 of detecting gestures, such as swipe gestures, non-swipe gestures, or a combination thereof, performed on an NED system 100 based on one or both of inertial sensor data and acoustic sensor data in accordance with at least some embodiments. The processes described below with respect to method 1500 have been described above in greater detail with reference to FIG. 1 to FIG. 13. It should be understood that method 1500 is not limited to the sequence of operations shown in FIG. 15, as at least some of the operations can be performed in parallel or in a different sequence. Moreover, in at least some embodiments, method 1500 can include one or more different operations than those shown in FIG. 15.

At block 1502, the detection component 312 obtains raw sensor data 322 generated by one or more sensors 310 at an NED system(s). As described above, the sensors 310 include microphones 116, IMUs 314, individual accelerometers, individual gyroscopes, individual magnetometers, and the like. The raw sensor data 322 includes inertial sensor data such as accelerometer data 322-1, acoustic sensor data such as microphone data 322-2, a combination thereof, and the like. At block 1504, the detection component 312 pre-processes the raw sensor data 322 to generate preprocessed sensor data 322. As described above, preprocessing the raw sensor data 322 includes, for example, normalizing the accelerometer data 322-1 and microphone data 322-2, transforming the raw sensor data 322 into a digital format, generating one or more waveforms representing the raw sensor data 322, performing one or more filtering operations, computing the STFT of one or both of the accelerometer data 322-1 and microphone data 322-2, transforming the raw (or preprocessed) sensor data 322 into the time-frequency domain, a combination thereof, and the like.

At block 1506, the detection component 312 implements one or more neural networks 328. However, in other embodiments, the neural network(s) 328 is not implemented. As described above, examples of neural networks 328 include a neural network 328 that takes raw sensor data 322 in the time domain as input and implements a CNN architectural configuration 334; a neural network 328 that takes raw sensor data 322 in the time domain as input and implements a TCN architectural configuration 334 with dilated convolutions; a neural network 328 that takes FFT transformed accelerometer data 322-1 in the time-frequency domain as input and implements a CNN architectural configuration 334; and a neural network 328 that takes FFT transformed microphone data 318-2 in the time-frequency domain as input and implements a TCN architectural configuration 334 having residual connections.

At block 1508, the detection component 312 analyzes a portion of the raw sensor data 322, preprocessed sensor data 322, or a combination thereof. As described above, in at least some embodiments, the detection component 312 analyzes overlapping windows of the sensor data 322. At block 1510, based on the analysis, the detection component 312 determines if this portion of the sensor data 322 includes any inertial characteristics or patterns indicative of a swipe gesture. In addition, or alternatively, at block 1512, based on the analysis, the detection component 312 determines if this portion of the sensor data 322 includes any acoustic characteristics or patterns indicative of a swipe gesture.

If the analyzed portion of sensor data 322 does not include any inertial or acoustic characteristics or patterns indicative of a swipe gesture, the process returns to block 1508 if there are portions of the sensor data 322 remaining to be analyzed. Otherwise, the process returns to block 1502. At block 1514, if the analyzed portion of sensor data 322 does include inertial or acoustic characteristics or patterns indicative of a swipe gesture, the detection component 312 determines that a swipe gesture(s) has been performed on the NED system 100. At block 1514, the detection component 312 outputs detected gesture information 332 that includes, for example, an indication that a swipe gesture was performed. In at least some embodiments, the detected gesture information 332 also includes a first set of attributes of the swipe gesture (or non-swipe gesture), such as direction (e.g., forward, downward, up, and down), and a second set of attributes of the swipe gesture, such as swipe magnitude (e.g., full swipe or half swipe). At block 1518, the NED system 100 performs one or more actions based on the detected swipe gesture and any gesture attributes provided by the detection component 312. As described above, examples of these actions include controlling the image source of the NED system 100, menu navigation or scrolling, settings adjustment, panning the view of a map or rotating a three-dimensional model, or causing an avatar to jump, crouch, run, or select items, and the like.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, at a near-eye display (NED) system, comprising:
analyzing a first set of sensor data, including one or both of inertial sensor data or acoustic sensor data, obtained from one or more sensors of the NED system; and
responsive to detecting, based on the analyzing, that the first set of sensor data includes one or both of inertial characteristics or acoustic characteristics corresponding to a gesture, generating an indication that the gesture has occurred at the NED system.

2. The method of claim 1, further comprising:
controlling at least one operation of the NED system responsive to the indication that the gesture has occurred.

3. The method of claim 1, wherein generating the indication further comprises:
generating an indication of attributes of the gesture including one or both of a first set of attributes indicating a direction of the gesture or a second set of attributes indicating a magnitude of the gesture.

4. The method of claim 3, further comprising:
identifying one or both of the direction of the gesture or the magnitude of the gesture based on at least one of the one or both of inertial characteristics or acoustic characteristics.

5. The method of claim 1, wherein the inertial sensor data includes accelerometer data, and the acoustic sensor data includes microphone data.

6. The method of claim 1, further comprising:
filtering the first set of sensor data to remove at least one of noise or frequencies below a cut-off frequency,
wherein the analyzing comprises analyzing the filtered set of sensor data.

7. The method of claim 1, further comprising:
transforming the first set of sensor data from a time domain to a time-frequency domain,
wherein the analyzing comprises analyzing the transformed first set of sensor data.

8. The method of claim 1, further comprising:
implementing at least one neural network,
wherein the analyzing comprises analyzing the first set of sensor data using the at least one neural network.

9. The method of claim 8, wherein the at least one neural network is one or more of:
a convolutional neural network (CNN) that takes raw sensor data in a time domain as input;
a temporal CNN that takes raw inertial sensor data in the time domain as input;
a CNN that takes inertial sensor data transformed into the time domain as input; or
a temporal CNN including residual connections that takes acoustic sensor data transformed into the time domain as input.

10. The method of claim 8, further comprising:
training the at least one neural network using a set of training data including labels identifying at least one or more of a start event of a gesture, an end event of a gesture, inertial characteristics, patterns of inertial characteristics, acoustic characteristics, patterns of acoustic characteristics, or gesture attributes.

11. The method of claim 10, further comprising:
automatically generating one or more of the labels based on at least:
applying a filter to a second set of sensor data, including one or more of inertial data or microphone data, to remove low-frequency artifacts;
responsive to applying the filter, performing principal component analysis (PCA) to reduce the second set of sensor data to one dimension;
responsive to performing the PCA, performing a Fast Fourier Transform (FFT) to transform the second set of sensor data to a time-frequency domain;
responsive to performing the FFT, calculating a mean of high-frequency bands within the second set of sensor data; and
responsive to calculating the mean of the high-frequency bands, identifying a local maxima of the second set of sensor data.

12. The method of claim 10, further comprising:
obtaining labeled sensor data, including one or more of inertial data or training microphone data, wherein the labels identify one or more of characteristics or attributes of gestures; and
for each processing window of a plurality of processing windows:
identifying a closest labeled gesture event with an end timestamp;
responsive to the end timestamp of the processing window being within a defined time interval after the end timestamp, identifying the processing window as a training sample for gestures of interest; and
responsive to the end timestamp of the processing window being outside the defined time interval after the end timestamp, identifying the processing window as a training sample for gestures not of interest,
wherein the set of training data includes the identified training samples for gestures of interest and the training samples for gestures not of interest.

13. A near-eye display (NED) system comprising:
an image source to project light representing imagery;
a waveguide to conduct the light from the image source toward an eye of a user; and
a processing device configured to:
perform an analysis of a first set of sensor data, including one or more of inertial sensor data or acoustic sensor data, obtained from one or more sensors of the NED system;
responsive to a detection, based on the analysis, that the first set of sensor data includes one or more of inertial characteristics or acoustic characteristics corresponding to a gesture, generate an indication that the gesture has occurred at the NED system; and
control the image source based on the indication that the gesture has occurred.

14. The NED system of claim 13, wherein the processing device is further configured to:
generate an indication of attributes of the gesture including one or more of a first set of attributes indicating a direction of the gesture or a second set of attributes indicating a magnitude of the gesture.

15. The NED system of claim 13, wherein the processing device is further configured to:
implement at least one neural network,
wherein the processing device is configured to perform the analysis by analyzing the first set of sensor data using the at least one neural network.

16. The NED system of claim 15, wherein the at least one neural network is one or more of:
a convolutional neural network (CNN) that takes raw sensor data in a time domain as input;
a temporal CNN that takes raw inertial sensor data in the time domain as input;
a CNN that takes inertial sensor data transformed into the time domain as input; or
a temporal CNN including residual connections that takes acoustic sensor data transformed into the time domain as input.

17. The NED system of claim 15, wherein the processing device is further configured to:
train the at least one neural network using a set of training data including labels identifying at least one or more of a start event of a gesture, an end event of a gesture, inertial characteristics, patterns of inertial characteristics, acoustic characteristics, patterns of acoustic characteristics, or gesture attributes.

18. The NED system of claim 17, wherein the processing device is further configured to automatically generate one or more of the labels based on at least:
applying a filter to a second set of sensor data, including one or more of inertial data or microphone data, to remove low-frequency artifacts;
responsive to applying the filter, performing principal component analysis (PCA) to reduce the second set of sensor data to one dimension;
responsive to performing the PCA, performing a Fast Fourier Transform (FFT) to transform the second set of sensor data to a time-frequency domain;
responsive to performing the FFT, calculating a mean of high-frequency bands within the second set of sensor data; and
responsive to calculating the mean of the high-frequency bands, identifying a local maxima of the second set of sensor data.

19. The NED system of claim 17, wherein the processing device is further configured to:
obtain labeled sensor data, including one or more of inertial data or training microphone data, wherein the labels identify one or more of characteristics or attributes of gestures; and
for each processing window of a plurality of processing windows:
identify a closest labeled gesture event with an end timestamp;
responsive to the end timestamp of the processing window being within a defined time interval after the end timestamp, identify the processing window as a training sample for gestures of interest; and
responsive to the end timestamp of the processing window being outside the defined time interval after the end timestamp, identify the processing window as a training sample for gestures not of interest,
wherein the set of training data includes the identified training samples for gestures of interest and the training samples for gestures not of interest.

20. A method, at a near-eye display (NED) system, comprising:
obtaining an input stream from one or more of a set of inertial sensors or a set of acoustic sensors of the NED system;
analyzing, by at least one neural network, the input stream;
responsive to the analyzing, determining, by the at least one neural network, that the input stream includes one or more of an inertial characteristic or an acoustic characteristic corresponding to a gesture having a directional component;
detecting, based on the one or more of the inertial characteristic or the acoustic characteristic, that the gesture having a directional component has been performed on the NED system; and
controlling at least one operation of the NED system responsive to the detecting that the gesture has been performed.

21. The method of claim 20, wherein detecting that the gesture has been performed further comprises:
detecting at least one of a direction or a magnitude of the gesture.

22. The method of claim 20, wherein the set of inertial sensors includes an accelerometer and the set of acoustic sensors includes a microphone.

23. The method of claim 20, further comprising:
filtering the input stream to remove at least one of noise or frequencies below a cut-off frequency,
wherein the analyzing comprises analyzing the filtered input stream.

24. The method of claim 20, further comprising:
transforming the input stream from a time domain to a time-frequency domain,
wherein the analyzing comprises analyzing the transformed input stream.

25. The method of claim 20, wherein the at least one neural network is one or more of:
a convolutional neural network (CNN) that takes raw sensor data in a time domain as input;
a temporal CNN that takes raw inertial sensor data in the time domain as input;
a CNN that takes inertial sensor data transformed into the time domain as input; or
a temporal CNN including residual connections that takes acoustic sensor data transformed into the time domain as input.

26. The method of claim 25, further comprising:
training the at least one neural network using a set of training data including labels identifying at least one or more of a start event of a gesture having a directional component, an end event of a gesture having a directional component, inertial characteristics, patterns of inertial characteristics, acoustic characteristics, patterns of acoustic characteristics, or gesture attributes.

27. The method of claim 26, further comprising:
obtaining labeled sensor data, including one or more of inertial data or training microphone data, wherein the labels identify one or more of characteristics or attributes of gestures having a directional component; and
for each processing window of a plurality of processing windows:
identifying a closest labeled gesture event with an end timestamp;
responsive to the end timestamp of the processing window being within a defined time interval after the end timestamp, identifying the processing window as a training sample for gestures having a directional component; and
responsive to the end timestamp of the processing window being outside the defined time interval after the end timestamp, identifying the processing window as a training sample for gestures absent a directional component,
wherein the set of training data includes the identified training samples for gestures having a directional component and the training samples for gestures absent a directional component.
